(19) United States
(12) Patent Application Publication
(10) Pub. No.: US 2012/0113244 A1
(43) Pub. Date: May 10, 2012

(54) METHODS, APPARATUS AND SYSTEMS FOR MARKING MATERIAL COLOR DETECTION IN CONNECTION WITH LOCATE AND MARKING OPERATIONS

(75) Inventors: Steven Nielsen, North Palm Beach, FL (US); Curtis Chambers, Palm Beach Gardens, FL (US); Jeffrey Farr, Jupiter, FL (US); Jack M. Vice, Stafford, VA (US); Tim Montague, (US)

(73) Assignee: CertusView Technologies, LLC

(21) Appl. No.: 13/210,237

(22) Filed: Aug. 15, 2011

Related U.S. Application Data
(60) Provisional application No. 61/373,475, filed on Aug. 13, 2010.

(51) Int. Cl. H04N 7/18

(52) U.S. Cl. 348/82; 348/E07.085

(57) ABSTRACT

Systems, methods, and apparatus for determining a color of marking material dispensed by a marking device onto a surface to mark a presence or an absence of at least one underground facility within a dig area that is planned to be excavated or disturbed during excavation activities. In some embodiments, one or more camera systems (e.g., digital video cameras) are mounted on a marking device to capture information (e.g., one or more of image information, color information, motion information and light level information) relating to the surface being marked. The camera system(s) may be mounted near a nozzle of a marking material dispenser, so as to capture information relating to freshly dispensed marking material on the surface being marked. The captured information may be analyzed to determine a color of the freshly dispensed marking material, which may then be correlated with a type of facilities being marked.

### CROSS-REFERENCE TO RELATED APPLICATIONS

This application claims a priority benefit, under 35 U.S.C. §119(e), to U.S. provisional patent application Ser. No. 61/373,475, filed on Aug. 13, 2010, entitled “Methods and Apparatus for Marking Material Color Detection in Connection with Locate and Marking Operations,” which provisional application is hereby incorporated by reference herein in its entirety.

### BACKGROUND

Field service operations may be any operation in which companies dispatch technicians and/or other staff to perform certain activities, for example, installations, services and/or repairs. Field service operations may exist in various industries, examples of which include, but are not limited to, network installations, utility installations, security systems, construction, medical equipment, heating, ventilating and air conditioning (HVAC) and the like.

An example of a field service operation in the construction industry is a so-called “locate and marking operation,” also commonly referred to more simply as a “locate operation” (or sometimes merely as “a locate”). In a typical locate operation, a locate technician visits a work site in which there is a plan to disturb the ground (e.g., excavate, dig one or more holes and/or trenches, bore, etc.) so as to determine a presence or an absence of one or more underground facilities (such as various types of utility cables and pipes) in a dig area to be excavated or disturbed at the work site. In some instances, a locate operation may be requested for a “design” project, in which there may be no immediate plan to excavate or otherwise disturb the ground, but nonetheless information about a presence or absence of one or more underground facilities at a work site may be valuable to inform a planning, permitting and/or engineering design phase of a future construction project.

In many states, an excavator who plans to disturb ground at a work site is required by law to notify any potentially affected underground facility owners prior to undertaking an excavation activity. Advanced notice of excavation activities may be provided by an excavator (or another party) by contacting a “one-call center.” One-call centers typically are operated by a consortium of underground facility owners for the purposes of receiving excavation notices and in turn notifying facility owners and/or their agents of a plan to excavate. As part of an advanced notification, excavators typically provide to the one-call center various information relating to the planned activity, including a location (e.g., address) of the work site and a description of the dig area to be excavated or otherwise disturbed at the work site.

FIG. 1 illustrates an example in which a locate operation is initiated as a result of an excavator 3110 providing an excavation notice to a one-call center 3120. An excavation notice also is commonly referred to as a “locate request,” and may be provided by the excavator to the one-call center via an electronic mail message, information entry via a website maintained by the one-call center, or a telephone conversation between the excavator and a human operator at the one-call center. The locate request may include an address or some other location-related information describing the geographic location of a work site at which the excavation is to be performed, as well as a description of the dig area (e.g., a text description), such as its location relative to certain landmarks and/or its approximate dimensions, within which there is a plan to disturb the ground at the work site. One-call centers similarly may receive locate requests for design projects (for which, as discussed above, there may be no immediate plan to excavate or otherwise disturb the ground).

Once facilities implicated by the locate request are identified by a one-call center (e.g., via a polygon map/buffer zone process), the one-call center generates a “locate request ticket” (also known as a “locate ticket,” or simply a “ticket”). The locate request ticket essentially constitutes an instruction to inspect a work site and typically identifies the work site of the proposed excavation or design and a description of the dig area, typically lists on the ticket all of the underground facilities that may be present at the work site (e.g., by providing a member code for the facility owner whose polygon falls within a given buffer zone), and may also include various other information relevant to the proposed excavation or design (e.g., the name of the excavation company, a name of a property owner or party contracting the excavation company to perform the excavation, etc.). The one-call center sends the ticket to one or more underground facility owners 3140 and/or one or more locate service providers 3130 (who may be acting as contracted agents of the facility owners) so that they can conduct a locate and marking operation to verify a presence or absence of the underground facilities in the dig area. For example, in some instances, a given underground facility owner 3140 may operate its own fleet of locate technicians (e.g., locate technician 3145), in which case the one-call center 3120 may send the ticket to the underground facility owner 3140. In other instances, a given facility owner may contract with a locate service provider to receive locate request tickets and perform a locate and marking operation in response to received tickets on their behalf.

Upon receiving the locate request, a locate service provider or a facility owner (hereafter referred to as a “ticket recipient”) may dispatch a locate technician (e.g., locate technician 3150) to the work site of planned excavation to determine a presence or absence of one or more underground facilities in the dig area to be excavated or otherwise disturbed. A typical first step for the locate technician includes utilizing an underground facility “locate device,” which is an instrument or set of instruments (also referred to commonly as a “locate set”) for detecting facilities that are concealed in some manner, such as cables and pipes that are located underground. The locate device is employed by the technician to verify the presence or absence of underground facilities indicated in the locate request ticket as potentially present in the dig area (e.g., via the facility owner member codes listed in the ticket). This process is often referred to as a “locate operation.”

In one example of a locate operation, an underground facility locate device is used to detect electromagnetic fields that are generated by an applied signal provided along a length of a target facility to be identified. In this example, a locate device may include both a signal transmitter to provide the applied signal (e.g., which is coupled by the locate technician to a tracer wire disposed along a length of a facility), and a signal receiver which is generally a hand-held apparatus carried by the locate technician as the technician walks around the dig area to search for underground facilities. FIG. 2 illustrates a conventional locate device 3500 (indicated by the dashed box) that includes a transmitter 3505 and a locate receiver 3510. The transmitter 3505 is connected, via a connection point 3525, to a target object (in this example, underground facility 3515) located in the ground 3520. The transmitter generates the applied signal 3530, which is coupled to the underground facility via the connection point (e.g., to a tracer wire along the facility), resulting in the generation of a magnetic field 3535. The magnetic field in turn is detected by the locate receiver 3510, which itself may include one or more detection antenna (not shown). The locate receiver 3510 indicates a presence of a facility when it detects electromagnetic fields arising from the applied signal 3530. Conversely, the absence of a signal detected by the locate receiver generally indicates the absence of the target facility.

In yet another example, a locate device employed for a locate operation may include a single instrument, similar in some respects to a conventional metal detector. In particular, such an instrument may include an oscillator to generate an alternating current that passes through a coil, which in turn produces a first magnetic field. If a piece of electrically conductive metal is in close proximity to the coil (e.g., if an underground facility having a metal component is below/near the coil of the instrument), eddy currents are induced in the metal and the metal produces its own magnetic field, which in turn affects the first magnetic field. The instrument may include a second coil to measure changes to the first magnetic field, thereby facilitating detection of metallic objects.

In addition to the locate operation, the locate technician also generally performs a “marking operation,” in which the technician marks the presence (and in some cases the absence) of a given underground facility in the dig area based on the various signals detected (or not detected) during the locate operation. For this purpose, the locate technician conventionally utilizes a “marking device” to dispense a marking material on, for example, the ground, pavement, or other surface along a detected underground facility. Marking material may be any material, substance, compound, and/or element, used or which may be used separately or in combination to mark, signify, and/or indicate. Examples of marking materials may include, but are not limited to, paint, chalk, dye, and/or iron. Marking devices, such as paint marking devices and/or paint marking wheels, provide a convenient method of dispensing marking materials onto surfaces, such as onto the surface of the ground or pavement.

FIGS. 3A and 3B illustrate a conventional marking device 50 with a mechanical actuation system to dispense paint as a marker. Generally speaking, the marking device 50 includes a handle 38 at a proximal end of an elongated shaft 36 and resembles a sort of “walking stick,” such that a technician may operate the marking device while standing/walking in an upright or substantially upright position. A marking dispenser holder 40 is coupled to a distal end of the shaft 36 so as to contain and support a marking dispenser 56, e.g., an aerosol paint can having a spray nozzle 54. Typically, a marking dispenser in the form of an aerosol paint can is placed into the holder 40 upside down, such that the spray nozzle 54 is proximate to the distal end of the shaft (close to the ground, pavement or other surface on which markers are to be dispensed).

In FIGS. 3A and 3B, the mechanical actuation system of the marking device 50 includes an actuator or mechanical trigger 42 proximate to the handle 38 that is actuated/triggered by the technician (e.g., via pulling, depressing or squeezing with fingers/hand). The actuator 42 is connected to a mechanical coupler 52 (e.g., a rod) disposed inside and along a length of the elongated shaft 36. The coupler 52 is in turn connected to an actuation mechanism 58, at the distal end of the shaft 36, which mechanism extends outward from the shaft in the direction of the spray nozzle 54. Thus, the actuator 42, the mechanical coupler 52, and the actuation mechanism 58 constitute the mechanical actuation system of the marking device 50.

FIG. 3A shows the mechanical actuation system of the conventional marking device 50 in the non-actuated state, wherein the actuator 42 is “at rest” (not being pulled) and, as a result, the actuation mechanism 58 is not in contact with the spray nozzle 54. FIG. 3B shows the marking device 50 in the actuated state, wherein the actuator 42 is being actuated (pulled, depressed, squeezed) by the technician. When actuated, the actuator 42 displaces the mechanical coupler 52 and the actuation mechanism 58 such that the actuation mechanism contacts and applies pressure to the spray nozzle 54, thus causing the spray nozzle to deflect slightly and dispense paint. The mechanical actuation system is spring-loaded so that it automatically returns to the non-actuated state (FIG. 3A) when the actuator 42 is released.

In some environments, arrows, flags, darts, or other types of physical marks may be used to mark the presence or absence of an underground facility in a dig area, in addition to or as an alternative to a material applied to the ground (such as paint, chalk, dye, tape) along the path of a detected utility. The marks resulting from any of a wide variety of materials and/or objects used to indicate a presence or absence of underground facilities generally are referred to as “locate marks.” Often, different color materials and/or physical objects may be used for locate marks, wherein different colors correspond to different utility types. For example, the American Public Works Association (APWA) has established a standardized color-coding system for utility identification for use by public agencies, utilities, contractors and various groups involved in ground excavation (e.g., red=electric power lines and cables; blue=potable water; orange=telecommunication lines; yellow=gas, oil, steam). In some cases, the technician also may provide one or more marks to indicate that no facility was found in the dig area (sometimes referred to as a “clear”). Marking materials meeting the APWA color standards are available commercially from a variety of vendors. One exemplary vendor, Krylon, provides various paints, chalks, etc. having colors such as “APWA Red,” “APWA Blue,” etc.

As mentioned above, the foregoing activity of identifying and marking a presence or absence of one or more underground facilities generally is referred to for completeness as a “locate and marking operation.” However, in light of common parlance adopted in the construction industry, and/or for the sake of brevity, one or both of the respective locate and marking functions may be referred to in some instances simply as a “locate operation” or a “locate” (i.e., without making any specific reference to the marking function). Accordingly, it should be appreciated that any reference in the relevant arts to the task of a locate technician simply as a “locate operation” or a “locate” does not necessarily exclude the marking portion of the overall process. At the same time, in some contexts a locate operation is identified separately from a marking operation, wherein the former relates more specifically to detection-related activities and the latter relates more specifically to marking-related activities.

Inaccurate locating and/or marking of underground facilities can result in physical damage to the facilities, property damage, and/or personal injury during the excavation process that, in turn, can expose a facility owner or contractor to significant legal liability. When underground facilities are damaged and/or when property damage or personal injury results from damaging an underground facility during an excavation, the excavator may assert that the facility was not accurately located and/or marked by a locate technician, while the locate contractor who dispatched the technician may in turn assert that the facility was indeed properly located and marked. Proving whether the underground facility was properly located and marked can be difficult after the excavation (or after some damage, e.g., a gas explosion), because in many cases the physical locate marks (e.g., the marking material or other physical marks used to mark the facility on the surface of the dig area) will have been disturbed or destroyed during the excavation process (and/or damage resulting from excavation).

Previous efforts at documenting locate operations have focused primarily on locate devices that employ electromagnetic fields to determine the presence of an underground facility. For example, U.S. Pat. No. 5,576,973, naming inventor Alan Haddy and entitled “Apparatus and Method for Obtaining Geographical Positional Data for an Object Located Underground” (hereafter “Haddy”), is directed to a locate device (i.e., a “locator”) that receives and stores data from a global positioning system (“GPS”) to identify the position of the locate device as an underground object (e.g., a cable) is detected by the locate device. Haddy notes that by recording geographical position data relating to the detected underground object, there is no need to physically mark the location of the underground object on the ground surface, and the recorded position data may be used in the future to re-locate the underground object.

Similarly, U.S. Pat. No. 7,319,387, naming inventors Willson et al. and entitled “GPS Interface for Locating Device” (hereafter “Willson”), is directed to a locate device for locating “position markers,” i.e., passive antennas that reflect back RF signals and which are installed along buried utilities. In Willson, a GPS device may be communicatively coupled to the locate device, or alternatively provided as an integral part of the locate device, to store GPS coordinate data associated with position markers detected by the locate device. Electronic memory is provided in the locate device for storing a data record of the GPS coordinate data, and the data record may be uploaded to a remote computer and used to update a mapping database for utilities.

U.S. Publication No. 2006/0282280, naming inventors Stotz et al. and entitled “Ticket and Data Management” (hereafter “Stotz”), also is directed to a locate device (i.e., a “locator”) including a GPS receiver. Upon detection of the presence of a utility line, Stotz' locate device can update ticket data with GPS coordinates for the detected utility line. Once the locate device has updated the ticket data, the reconfigured ticket data may be transmitted to a network.

U.S. Publication No. 2007/0219722, naming inventors Sawyer, Jr. et al. and entitled “System and Method for Collecting and Updating Geographical Data” (hereafter “Sawyer”), is directed to collecting and recording data representative of the location and characteristics of utilities and infrastructure in the field for creating a grid or map. Sawyer employs a field data collection unit including a “locating pole” that is placed on top of or next to a utility to be identified and added to the grid or map. The locating pole includes an antenna coupled to a location determination system, such as a GPS unit, to provide longitudinal and latitudinal coordinates of the utility under or next to the end of the locating pole. The data gathered by the field data collection unit is sent to a server to provide a permanent record that may be used for damage prevention and asset management operations.

### SUMMARY

Applicants have recognized and appreciated that uncertainties which may be attendant to locate and marking operations may be significantly reduced by collecting various information particularly relating to the marking operation, rather than merely focusing on information relating to detection of underground facilities via a locate device. In many instances, excavators arriving to a work site have only physical locate marks on which to rely to indicate a presence or absence of underground facilities, and they are not generally privy to information that may have been collected previously during the locate operation. Accordingly, the integrity and accuracy of the physical locate marks applied during a marking operation arguably is significantly more important in connection with reducing risk of damage and/or injury during excavation than the location of where an underground facility was detected via a locate device during a locate operation.

Furthermore, Applicants have recognized and appreciated that the location at which an underground facility ultimately is detected during a locate operation is not always where the technician physically marks the ground, pavement or other surface during a marking operation; in fact, technician imprecision or negligence, as well as various ground conditions and/or different operating conditions amongst different locate device, may in some instances result in significant discrepancies between detected location and physical locate marks. Accordingly, having documentation (e.g., an electronic record) of where physical locate marks were actually dispensed (i.e., what an excavator encounters when arriving to a work site) is notably more relevant to the assessment of liability in the event of damage and/or injury than where an underground facility was detected prior to marking.

Examples of marking devices configured to collect some types of information relating specifically to marking operations are provided in U.S. publication no. 2008-0228294-A1, published Sep. 18, 2008, filed Mar. 13, 2007, and entitled “Marking System and Method With Location and/or Time Tracking,” and U.S. publication no. 2008-0245299-A1, published Oct. 9, 2008, filed Apr. 4, 2007, and entitled “Marking System and Method,” both of which publications are incorporated herein by reference. These publications describe, amongst other things, collecting information relating to the geographic location, time, and/or characteristics (e.g., color/type) of dispensed marking material from a marking device and generating an electronic record based on this collected information. Applicants have recognized and appreciated that collecting information relating to both geographic location and color of dispensed marking material provides for automated correlation of geographic information for a locate mark to facility type (e.g., red=electric power lines and cables; blue=potable water; orange=telecommunication lines; yellow=gas, oil, steam); in contrast, in conventional locate devices equipped with GPS capabilities as discussed above, there is no apparent automated provision for readily linking GPS information for a detected facility to the type of facility detected.

Applicants have also recognized and appreciated that building a more comprehensive electronic record of information relating to marking operations further facilitates ensuring the accuracy of such operations. For example, collecting and analyzing information relating to a color of a marking material being applied may facilitate ensuring accuracy of locate and marking operations (e.g., by ensuring that the color of marking material correctly corresponds to a type of detected underground facilities).

In sum, one embodiment of the present disclosure is directed to an apparatus for determining a color of marking material dispensed by a marking device onto a surface to mark a presence or an absence of at least one underground facility within a dig area, wherein at least a portion of the dig area is planned to be excavated or disturbed during excavation activities, the apparatus comprising: at least one communication interface; at least one memory to store processor-executable instructions; and at least one processor communicatively coupled to the at least one memory and the at least one communication interface. Upon execution of the processor-executable instructions, the at least one processor: A) analyzes at least one image of the surface being marked to obtain detected color information relating to the marking material dispensed by the marking device, the at least one image being captured by at least one camera attached to the marking device; B) retrieves, from the at least one memory, reference color information regarding a plurality of marking material colors; and C) generates marking material color information based at least in part on the detected color information and the reference color information.

Another embodiment of the present disclosure is directed to a method for use in a system comprising at least one communication interface, at least one memory to store processor-executable instructions, and at least one processor communicatively coupled to the at least one memory and the at least one communication interface. The method may be performed for determining a color of marking material dispensed by a marking device onto a surface to mark a presence or an absence of at least one underground facility within a dig area, wherein at least a portion of the dig area is planned to be excavated or disturbed during excavation activities. The method comprises acts of: A) analyzing at least one image of the surface being marked to obtain detected color information relating to the marking material dispensed by the marking device, the at least one image being captured by at least one camera attached to the marking device; B) retrieving, from the at least one memory, reference color information regarding a plurality of marking material colors; and C) generating marking material color information based at least in part on the detected color information and the reference color information.

Yet another embodiment of the present disclosure is directed to at least one non-transitory computer-readable storage medium encoded with at least one program including processor-executable instructions that, when executed by at least one processor, performs the above described method for determining a color of marking material dispensed by a marking device.

Yet another embodiment of the present disclosure is directed to a marking apparatus for performing a marking operation to mark on a surface a presence or an absence of at least one underground facility. The marking apparatus comprises: at least one actuator to dispense a marking material so as to form at least one locate mark on the surface to mark the presence or the absence of the at least one underground facility; at least one camera for capturing at least one image of the surface being marked; at least one user interface including at least one display device; at least one communication interface; at least one memory to store processor-executable instructions; and at least one processor communicatively coupled to the at least one memory, the at least one communication interface, the at least one user interface, and the at least one actuator. Upon execution of the processor-executable instructions, the at least one processor: A) analyzes the at least one image of the marked surface captured by the at least one camera, to obtain detected color information relating to the marking material dispensed by the marking device; B) retrieves, from the at least one memory, reference color information regarding a plurality of marking material colors; and C) generates marking material color information based at least in part on the detected color information and the reference color information.

Another embodiment is directed to an apparatus for determining a color of marking material dispensed by a marking device onto a surface to mark a presence or an absence of at least one underground facility within a dig area, wherein at least a portion of the dig area is planned to be excavated or disturbed during excavation activities. The apparatus comprises: at least one communication interface; at least one memory to store processor-executable instructions and reference color information regarding a plurality of marking material colors; and at least one processor communicatively coupled to the at least one memory and the at least one communication interface. Upon execution of the processor-executable instructions, the at least one processor: A) analyzes camera system data associated with the surface being marked to obtain detected color information relating to the marking material dispensed by the marking device, the camera system data being provided by at least one camera system attached to the marking device; B) retrieves, from the at least one memory, the reference color information; and C) generates marking material color information based at least in part on the detected color information and the reference color information.

Another embodiment is directed to a method, performed in a system comprising at least one communication interface, at least one memory to store processor-executable instructions, and at least one processor communicatively coupled to the at least one memory and the at least one communication interface, for determining a color of marking material dispensed by a marking device onto a surface to mark a presence or an absence of at least one underground facility within a dig area, wherein at least a portion of the dig area is planned to be excavated or disturbed during excavation activities. The method comprises: A) analyzing camera system data associated with the surface being marked to obtain detected color information relating to the marking material dispensed by the marking device, the camera system data being provided by at least one camera system attached to the marking device; B) retrieving, from the at least one memory, reference color information regarding a plurality of marking material colors; and C) generating marking material color information based at least in part on the detected color information and the reference color information.

Another embodiment is directed to at least one non-transitory computer-readable storage medium encoded with at least one program including processor-executable instructions that, when executed by at least one processor, perform a method for determining a color of marking material dispensed by a marking device onto a surface to mark a presence or an absence of at least one underground facility within a dig area, wherein at least a portion of the dig area is planned to be excavated or disturbed during excavation activities. The method comprises: A) analyzing camera system data associated with the surface being marked to obtain detected color information relating to the marking material dispensed by the marking device, the camera system data being provided by at least one camera system attached to the marking device; B) retrieving, from the at least one memory, reference color information regarding a plurality of marking material colors; and C) generating marking material color information based at least in part on the detected color information and the reference color information.

Another embodiment is directed to a marking apparatus for performing a marking operation to mark on a surface a presence or an absence of at least one underground facility. The marking apparatus comprises: at least one actuator to dispense a marking material so as to form at least one locate mark on the surface to mark the presence or the absence of the at least one underground facility; at least one camera system to provide camera system data relating to the surface being marked; at least one user interface including at least one display device; at least one communication interface; at least one memory to store processor-executable instructions; and at least one processor communicatively coupled to the at least one memory, the at least one communication interface, the at least one user interface, and the at least one actuator. Upon execution of the processor-executable instructions, the at least one processor: A) analyzes the camera system data to obtain detected color information relating to the marking material dispensed by the marking device; B) retrieves, from the at least one memory, reference color information regarding a plurality of marking material colors; and C) generates marking material color information based at least in part on the detected color information and the reference color information.

For purposes of the present disclosure, the term “dig area” refers to a specified area of a work site within which there is a plan to disturb the ground (e.g., excavate, dig holes and/or trenches, bore, etc.), and beyond which there is no plan to excavate in the immediate surroundings. Thus, the metes and bounds of a dig area are intended to provide specificity as to where some disturbance to the ground is planned at a given work site. It should be appreciated that a given work site may include multiple dig areas.

The term “facility” refers to one or more lines, cables, fibers, conduits, transmitters, receivers, or other physical objects or structures capable of or used for carrying, transmitting, receiving, storing, and providing utilities, energy, data, substances, and/or services, and/or any combination thereof. The term “underground facility” means any facility beneath the surface of the ground. Examples of facilities include, but are not limited to, oil, gas, water, sewer, power, telephone, data transmission, cable television (TV), and/or internet services.

The term “locate device” refers to any apparatus and/or device for detecting and/or inferring the presence or absence of any facility, including without limitation, any underground facility. In various examples, a locate device may include both a locate transmitter and a locate receiver (which in some instances may also be referred to collectively as a “locate instrument set,” or simply “locate set”).

The term “marking device” refers to any apparatus, mechanism, or other device that employs a marking dispenser for causing a marking material and/or marking object to be dispensed, or any apparatus, mechanism, or other device for electronically indicating (e.g., logging in memory) a location, such as a location of an underground facility. Additionally, the term “marking dispenser” refers to any apparatus, mechanism, or other device for dispensing and/or otherwise using, separately or in combination, a marking material and/or a marking object. An example of a marking dispenser may include, but is not limited to, a pressurized can of marking paint. The term “marking material” means any material, substance, compound, and/or element, used or which may be used separately or in combination to mark, signify, and/or indicate. Examples of marking materials may include, but are not limited to, paint, chalk, dye, and/or iron. The term “marking object” means any object and/or objects used or which may be used separately or in combination to mark, signify, and/or indicate. Examples of marking objects may include, but are not limited to, a flag, a dart, and arrow, and/or an RFID marking ball. It is contemplated that marking material may include marking objects. It is further contemplated that the terms “marking materials” or “marking objects” may be used interchangeably in accordance with the present disclosure.

The term “locate mark” means any mark, sign, and/or object employed to indicate the presence or absence of any underground facility. Examples of locate marks may include, but are not limited to, marks made with marking materials, marking objects, global positioning or other information, and/or any other means. Locate marks may be represented in any form including, without limitation, physical, visible, electronic, and/or any combination thereof.

The terms “actuate” or “trigger” (verb form) are used interchangeably to refer to starting or causing any device, program, system, and/or any combination thereof to work, operate, and/or function in response to some type of signal or stimulus. Examples of actuation signals or stimuli may include, but are not limited to, any local or remote, physical, audible, inaudible, visual, non-visual, electronic, mechanical, electromechanical, biomechanical, biosensing or other signal, instruction, or event. The terms “actuator” or “trigger” (noun form) are used interchangeably to refer to any method or device used to generate one or more signals or stimuli to cause or causing actuation. Examples of an actuator/trigger may include, but are not limited to, any form or combination of a lever, switch, program, processor, screen, microphone for capturing audible commands, and/or other device or method. An actuator/trigger may also include, but is not limited to, a device, software, or program that responds to any movement and/or condition of a user, such as, but not limited to, eye movement, brain activity, heart rate, other data, and/or the like, and generates one or more signals or stimuli in response thereto. In the case of a marking device or other marking mechanism (e.g., to physically or electronically mark a facility or other feature), actuation may cause marking material to be dispensed, as well as various data relating to the marking operation (e.g., geographic location, time stamps, characteristics of material dispensed, etc.) to be logged in an electronic file stored in memory. In the case of a locate device or other locate mechanism (e.g., to physically locate a facility or other feature), actuation may cause a detected signal strength, signal frequency, depth, or other information relating to the locate operation to be logged in an electronic file stored in memory.

The terms “locate and marking operation,” “locate operation,” and “locate” generally are used interchangeably and refer to any activity to detect, infer, and/or mark the presence or absence of an underground facility. In some contexts, the term “locate operation” is used to more specifically refer to detection of one or more underground facilities, and the term “marking operation” is used to more specifically refer to using a marking material and/or one or more marking objects to mark a presence or an absence of one or more underground facilities. The term “locate technician” refers to an individual performing a locate operation. A locate and marking operation often is specified in connection with a dig area, at least a portion of which may be excavated or otherwise disturbed during excavation activities.

The term “user” refers to an individual utilizing a locate device and/or a marking device and may include, but is not limited to, land surveyors, locate technicians, and support personnel.

The terms “locate request” and “excavation notice” are used interchangeably to refer to any communication to request a locate and marking operation. The term “locate request ticket” (or simply “ticket”) refers to any communication or instruction to perform a locate operation. A ticket might specify, for example, the address or description of a dig area to be marked, the day and/or time that the dig area is to be marked, and/or whether the user is to mark the excavation area for certain gas, water, sewer, power, telephone, cable television, and/or some other underground facility. The term “historical ticket” refers to past tickets that have been completed.

The following U.S. patents and published applications are hereby incorporated herein by reference:

U.S. Pat. No. 7,640,105, issued Dec. 29, 2009, filed Mar. 13, 2007, and entitled “Marking System and Method With Location and/or Time Tracking;”

U.S. publication no. 2010-0094553-A1, published Apr. 15, 2010, filed Dec. 16, 2009, and entitled “Systems and Methods for Using Location Data and/or Time Data to Electronically Display Dispensing of Markers by A Marking System or Marking Tool;”

U.S. publication no. 2008-0245299-A1, published Oct. 9, 2008, filed Apr. 4, 2007, and entitled “Marking System and Method;”

U.S. publication no. 2009-0013928-A1, published Jan. 15, 2009, filed Sep. 24, 2008, and entitled “Marking System and Method;”

U.S. publication no. 2010-0090858-A1, published Apr. 15, 2010, filed Dec. 16, 2009, and entitled “Systems and Methods for Using Marking Information to Electronically Display Dispensing of Markers by a Marking System or Marking Tool;”

U.S. publication no. 2009-0238414-A1, published Sep. 24, 2009, filed Mar. 18, 2008, and entitled “Virtual White Lines for Delimiting Planned Excavation Sites;”

U.S. publication no. 2009-0241045-A1, published Sep. 24, 2009, filed Sep. 26, 2008, and entitled “Virtual White Lines for Delimiting Planned Excavation Sites;”

U.S. publication no. 2009-0238415-A1, published Sep. 24, 2009, filed Sep. 26, 2008, and entitled “Virtual White Lines for Delimiting Planned Excavation Sites;”

U.S. publication no. 2009-0241046-A1, published Sep. 24, 2009, filed Jan. 16, 2009, and entitled “Virtual White Lines for Delimiting Planned Excavation Sites;”

U.S. publication no. 2009-0238416-A1, published Sep. 24, 2009, filed Jan. 16, 2009, and entitled “Virtual White Lines for Delimiting Planned Excavation Sites;”

U.S. publication no. 2009-0237408-A1, published Sep. 24, 2009, filed Jan. 16, 2009, and entitled “Virtual White Lines for Delimiting Planned Excavation Sites;”

U.S. publication no. 2011-0135163-A1, published Jun. 9, 2011, filed Feb. 16, 2011, and entitled “Methods and Apparatus for Providing Unbuffered Dig Area Indicators on Aerial Images to Delimit Planned Excavation Sites;”

U.S. publication no. 2009-0202101-A1, published Aug. 13, 2009, filed Feb. 12, 2008, and entitled “Electronic Manifest of Underground Facility Locate Marks;”

U.S. publication no. 2009-0202110-A1, published Aug. 13, 2009, filed Sep. 11, 2008, and entitled “Electronic Manifest of Underground Facility Locate Marks;”

U.S. publication no. 2009-0201311-A1, published Aug. 13, 2009, filed Jan. 30, 2009, and entitled “Electronic Manifest of Underground Facility Locate Marks;”

U.S. publication no. 2009-0202111-A1, published Aug. 13, 2009, filed Jan. 30, 2009, and entitled “Electronic Manifest of Underground Facility Locate Marks;”

U.S. publication no. 2009-0204625-A1, published Aug. 13, 2009, filed Feb. 5, 2009, and entitled “Electronic Manifest of Underground Facility Locate Operation;”

U.S. publication no. 2009-0204466-A1, published Aug. 13, 2009, filed Sep. 4, 2008, and entitled “Ticket Approval System For and Method of Performing Quality Control In Field Service Applications;”

U.S. publication no. 2009-0207019-A1, published Aug. 20, 2009, filed Apr. 30, 2009, and entitled “Ticket Approval System For and Method of Performing Quality Control In Field Service Applications;”

U.S. publication no. 2009-0210284-A1, published Aug. 20, 2009, filed Apr. 30, 2009, and entitled “Ticket Approval System For and Method of Performing Quality Control In Field Service Applications;”

U.S. publication no. 2009-0210297-A1, published Aug. 20, 2009, filed Apr. 30, 2009, and entitled “Ticket Approval System For and Method of Performing Quality Control In Field Service Applications;”

U.S. publication no. 2009-0210298-A1, published Aug. 20, 2009, filed Apr. 30, 2009, and entitled “Ticket Approval System For and Method of Performing Quality Control In Field Service Applications;”

U.S. publication no. 2009-0210285-A1, published Aug. 20, 2009, filed Apr. 30, 2009, and entitled “Ticket Approval System For and Method of Performing Quality Control In Field Service Applications;”

U.S. publication no. 2009-0324815-A1, published Dec. 31, 2009, filed Apr. 24, 2009, and entitled “Marking Apparatus and Marking Methods Using Marking Dispenser with Machine-Readable ID Mechanism;”

U.S. publication no. 2010-0006667-A1, published Jan. 14, 2010, filed Apr. 24, 2009, and entitled, “Marker Detection Mechanisms for use in Marking Devices And Methods of Using Same;”

U.S. publication no. 2010-0085694 A1, published Apr. 8, 2010, filed Sep. 30, 2009, and entitled, “Marking Device Docking Stations and Methods of Using Same;”

U.S. publication no. 2010-0085701 A1, published Apr. 8, 2010, filed Sep. 30, 2009, and entitled, “Marking Device Docking Stations Having Security Features and Methods of Using Same;”

U.S. publication no. 2010-0084532 A1, published Apr. 8, 2010, filed Sep. 30, 2009, and entitled, “Marking Device Docking Stations Having Mechanical Docking and Methods of Using Same;”

U.S. publication no. 2010-0088032-A1, published Apr. 8, 2010, filed Sep. 29, 2009, and entitled, “Methods, Apparatus and Systems for Generating Electronic Records of Locate And Marking Operations, and Combined Locate and Marking Apparatus for Same;”

U.S. publication no. 2010-0117654 A1, published May 13, 2010, filed Dec. 30, 2009, and entitled, “Methods and Apparatus for Displaying an Electronic Rendering of a Locate and/or Marking Operation Using Display Layers;”

U.S. publication no. 2010-0086677 A1, published Apr. 8, 2010, filed Aug. 11, 2009, and entitled, “Methods and Apparatus for Generating an Electronic Record of a Marking Operation Including Service-Related Information and Ticket Information;”

U.S. publication no. 2010-0086671 A1, published Apr. 8, 2010, filed Nov. 20, 2009, and entitled, “Methods and Apparatus for Generating an Electronic Record of A Marking Operation Including Service-Related Information and Ticket Information;”

U.S. publication no. 2010-0085376 A1, published Apr. 8, 2010, filed Oct. 28, 2009, and entitled, “Methods and Apparatus for Displaying an Electronic Rendering of a Marking Operation Based on an Electronic Record of Marking Information;”

U.S. publication no. 2010-0088164-A1, published Apr. 8, 2010, filed Sep. 30, 2009, and entitled, “Methods and Apparatus for Analyzing Locate and Marking Operations with Respect to Facilities Maps;”

U.S. publication no. 2010-0088134 A1, published Apr. 8, 2010, filed Oct. 1, 2009, and entitled, “Methods and Apparatus for Analyzing Locate and Marking Operations with Respect to Historical Information;”

U.S. publication no. 2010-0088031 A1, published Apr. 8, 2010, filed Sep. 28, 2009, and entitled, “Methods and Apparatus for Generating an Electronic Record of Environmental Landmarks Based on Marking Device Actuations;”

U.S. publication no. 2010-0188407 A1, published Jul. 29, 2010, filed Feb. 5, 2010, and entitled “Methods and Apparatus for Displaying and Processing Facilities Map Information and/or Other Image Information on a Marking Device;”

U.S. publication no. 2010-0198663 A1, published Aug. 5, 2010, filed Feb. 5, 2010, and entitled “Methods and Apparatus for Overlaying Electronic Marking Information on Facilities Map Information and/or Other Image Information Displayed on a Marking Device;”

U.S. publication no. 2010-0188215 A1, published Jul. 29, 2010, filed Feb. 5, 2010, and entitled “Methods and Apparatus for Generating Alerts on a Marking Device, Based on Comparing Electronic Marking Information to Facilities Map Information and/or Other Image Information;”

U.S. publication no. 2010-0188088 A1, published Jul. 29, 2010, filed Feb. 5, 2010, and entitled “Methods and Apparatus for Displaying and Processing Facilities Map Information and/or Other Image Information on a Locate Device;”

U.S. publication no. 2010-0189312 A1, published Jul. 29, 2010, filed Feb. 5, 2010, and entitled “Methods and Apparatus for Overlaying Electronic Locate Information on Facilities Map Information and/or Other Image Information Displayed on a Locate Device;”

U.S. publication no. 2010-0188216 A1, published Jul. 29, 2010, filed Feb. 5, 2010, and entitled “Methods and Apparatus for Generating Alerts on a Locate Device, Based ON Comparing Electronic Locate Information TO Facilities Map Information and/or Other Image Information;”

U.S. publication no. 2010-0189887 A1, published Jul. 29, 2010, filed Feb. 11, 2010, and entitled “Marking Apparatus Having Enhanced Features for Underground Facility Marking Operations, and Associated Methods and Systems;”

U.S. publication no. 2010-0256825-A1, published Oct. 7, 2010, filed Jun. 9, 2010, and entitled “Marking Apparatus Having Operational Sensors For Underground Facility Marking Operations, And Associated Methods And Systems;”

U.S. publication no. 2010-0255182-A1, published Oct. 7, 2010, filed Jun. 9, 2010, and entitled “Marking Apparatus Having Operational Sensors For Underground Facility Marking Operations, And Associated Methods And Systems;”

U.S. publication no. 2010-0245086-A1, published Sep. 30, 2010, filed Jun. 9, 2010, and entitled “Marking Apparatus Configured To Detect Out-Of-Tolerance Conditions In Connection With Underground Facility Marking Operations, And Associated Methods And Systems;”

U.S. publication no. 2010-0247754-A1, published Sep. 30, 2010, filed Jun. 9, 2010, and entitled “Methods and Apparatus For Dispensing Marking Material In Connection With Underground Facility Marking Operations Based on Environmental Information and/or Operational Information;”

U.S. publication no. 2010-0262470-A1, published Oct. 14, 2010, filed Jun. 9, 2010, and entitled “Methods, Apparatus, and Systems For Analyzing Use of a Marking Device By a Technician To Perform An Underground Facility Marking Operation;”

U.S. publication no. 2010-0263591-A1, published Oct. 21, 2010, filed Jun. 9, 2010, and entitled “Marking Apparatus Having Environmental Sensors and Operations Sensors for Underground Facility Marking Operations, and Associated Methods and Systems;”

U.S. publication no. 2010-0188245 A1, published Jul. 29, 2010, filed Feb. 11, 2010, and entitled “Locate Apparatus Having Enhanced Features for Underground Facility Locate Operations, and Associated Methods and Systems;”

U.S. publication no. 2010-0253511-A1, published Oct. 7, 2010, filed Jun. 18, 2010, and entitled “Locate Apparatus Configured to Detect Out-of-Tolerance Conditions in Connection with Underground Facility Locate Operations, and Associated Methods and Systems;”

U.S. publication no. 2010-0257029-A1, published Oct. 7, 2010, filed Jun. 18, 2010, and entitled “Methods, Apparatus, and Systems For Analyzing Use of a Locate Device By a Technician to Perform an Underground Facility Locate Operation;”

U.S. publication no. 2010-0253513-A1, published Oct. 7, 2010, filed Jun. 18, 2010, and entitled “Locate Transmitter Having Enhanced Features For Underground Facility Locate Operations, and Associated Methods and Systems;”

U.S. publication no. 2010-0253514-A1, published Oct. 7, 2010, filed Jun. 18, 2010, and entitled “Locate Transmitter Configured to Detect Out-of-Tolerance Conditions In Connection With Underground Facility Locate Operations, and Associated Methods and Systems;”

U.S. publication no. 2010-0256912-A1, published Oct. 7, 2010, filed Jun. 18, 2010, and entitled “Locate Apparatus for Receiving Environmental Information Regarding Underground Facility Marking Operations, and Associated Methods and Systems;”

U.S. publication no. 2009-0204238-A1, published Aug. 13, 2009, filed Feb. 2, 2009, and entitled “Electronically Controlled Marking Apparatus and Methods;”

U.S. publication no. 2009-0208642-A1, published Aug. 20, 2009, filed Feb. 2, 2009, and entitled “Marking Apparatus and Methods For Creating an Electronic Record of Marking Operations;”

U.S. publication no. 2009-0210098-A1, published Aug. 20, 2009, filed Feb. 2, 2009, and entitled “Marking Apparatus and Methods For Creating an Electronic Record of Marking Apparatus Operations;”

U.S. publication no. 2009-0201178-A1, published Aug. 13, 2009, filed Feb. 2, 2009, and entitled “Methods For Evaluating Operation of Marking Apparatus;”

U.S. publication no. 2009-0238417-A1, published Sep. 24, 2009, filed Feb. 6, 2009, and entitled “Virtual White Lines for Indicating Planned Excavation Sites on Electronic Images;”

U.S. publication no. 2010-0205264-A1, published Aug. 12, 2010, filed Feb. 10, 2010, and entitled “Methods, Apparatus, and Systems for Exchanging Information Between Excavators and Other Entities Associated with Underground Facility Locate and Marking Operations;”

U.S. publication no. 2010-0205031-A1, published Aug. 12, 2010, filed Feb. 10, 2010, and entitled “Methods, Apparatus, and Systems for Exchanging Information Between Excavators and Other Entities Associated with Underground Facility Locate and Marking Operations;”

U.S. publication no. 2010-0259381-A1, published Oct. 14, 2010, filed Jun. 28, 2010, and entitled “Methods, Apparatus and Systems for Notifying Excavators and Other Entities of the Status of in-Progress Underground Facility Locate and Marking Operations;”

U.S. publication no. 2010-0262670-A1, published Oct. 14, 2010, filed Jun. 28, 2010, and entitled “Methods, Apparatus and Systems for Communicating Information Relating to the Performance of Underground Facility Locate and Marking Operations to Excavators and Other Entities;”

U.S. publication no. 2010-0259414-A1, published Oct. 14, 2010, filed Jun. 28, 2010, and entitled “Methods, Apparatus And Systems For Submitting Virtual White Line Drawings And Managing Notifications In Connection With Underground Facility Locate And Marking Operations;”

U.S. publication no. 2010-0268786-A1, published Oct. 21, 2010, filed Jun. 28, 2010, and entitled “Methods, Apparatus and Systems for Requesting Underground Facility Locate and Marking Operations and Managing Associated Notifications;”

U.S. publication no. 2010-0201706-A1, published Aug. 12, 2010, filed Jun. 1, 2009, and entitled “Virtual White Lines (VWL) for Delimiting Planned Excavation Sites of Staged Excavation Projects;”

U.S. publication no. 2010-0205555-A1, published Aug. 12, 2010, filed Jun. 1, 2009, and entitled “Virtual White Lines (VWL) for Delimiting Planned Excavation Sites of Staged Excavation Projects;”

U.S. publication no. 2010-0205195-A1, published Aug. 12, 2010, filed Jun. 1, 2009, and entitled “Methods and Apparatus for Associating a Virtual White Line (VWL) Image with Corresponding Ticket Information for an Excavation Project;”

U.S. publication no. 2010-0205536-A1, published Aug. 12, 2010, filed Jun. 1, 2009, and entitled “Methods and Apparatus for Controlling Access to a Virtual White Line (VWL) Image for an Excavation Project;”

U.S. publication no. 2010-0228588-A1, published Sep. 9, 2010, filed Feb. 11, 2010, and entitled “Management System, and Associated Methods and Apparatus, for Providing Improved Visibility, Quality Control and Audit Capability for Underground Facility Locate and/or Marking Operations;”

U.S. publication no. 2010-0324967-A1, published Dec. 23, 2010, filed Jul. 9, 2010, and entitled “Management System, and Associated Methods and Apparatus, for Dispatching Tickets, Receiving Field Information, and Performing A Quality Assessment for Underground Facility Locate and/or Marking Operations;”

U.S. publication no. 2010-0318401-A1, published Dec. 16, 2010, filed Jul. 9, 2010, and entitled “Methods and Apparatus for Performing Locate and/or Marking Operations with Improved Visibility, Quality Control and Audit Capability;”

U.S. publication no. 2010-0318402-A1, published Dec. 16, 2010, filed Jul. 9, 2010, and entitled “Methods and Apparatus for Managing Locate and/or Marking Operations;”

U.S. publication no. 2010-0318465-A1, published Dec. 16, 2010, filed Jul. 9, 2010, and entitled “Systems and Methods for Managing Access to Information Relating to Locate and/or Marking Operations;”

U.S. publication no. 2010-0201690-A1, published Aug. 12, 2010, filed Apr. 13, 2009, and entitled “Virtual White Lines (VWL) Application for Indicating a Planned Excavation or Locate Path;”

U.S. publication no. 2010-0205554-A1, published Aug. 12, 2010, filed Apr. 13, 2009, and entitled “Virtual White Lines (VWL) Application for Indicating an Area of Planned Excavation;”

U.S. publication no. 2009-0202112-A1, published Aug. 13, 2009, filed Feb. 11, 2009, and entitled “Searchable Electronic Records of Underground Facility Locate Marking Operations;”

U.S. publication no. 2009-0204614-A1, published Aug. 13, 2009, filed Feb. 11, 2009, and entitled “Searchable Electronic Records of Underground Facility Locate Marking Operations;”

U.S. publication no. 2011-0060496-A1, published Mar. 10, 2011, filed Aug. 10, 2010, and entitled “Systems and Methods for Complex Event Processing of Vehicle Information and Image Information Relating to a Vehicle;”

U.S. publication no. 2011-0093162-A1, published Apr. 21, 2011, filed Dec. 28, 2010, and entitled “Systems And Methods For Complex Event Processing Of Vehicle-Related Information;”

U.S. publication no. 2011-0093306-A1, published Apr. 21, 2011, filed Dec. 28, 2010, and entitled “Fleet Management Systems And Methods For Complex Event Processing Of Vehicle-Related Information Via Local And Remote Complex Event Processing Engines;”

U.S. publication no. 2011-0093304-A1, published Apr. 21, 2011, filed Dec. 29, 2010, and entitled “Systems And Methods For Complex Event Processing Based On A Hierarchical Arrangement Of Complex Event Processing Engines;”

U.S. publication no. 2010-0257477-A1, published Oct. 7, 2010, filed Apr. 2, 2010, and entitled “Methods, Apparatus, and Systems for Documenting and Reporting Events Via Time-Elapsed Geo-Referenced Electronic Drawings;”

U.S. publication no. 2010-0256981-A1, published Oct. 7, 2010, filed Apr. 2, 2010, and entitled “Methods, Apparatus, and Systems for Documenting and Reporting Events Via Time-Elapsed Geo-Referenced Electronic Drawings;”

U.S. publication no. 2010-0205032-A1, published Aug. 12, 2010, filed Feb. 11, 2010, and entitled “Marking Apparatus Equipped with Ticket Processing Software for Facilitating Marking Operations, and Associated Methods;”

U.S. publication no. 2011-0035251-A1, published Feb. 10, 2011, filed Jul. 15, 2010, and entitled “Methods, Apparatus, and Systems for Facilitating and/or Verifying Locate and/or Marking Operations;”

U.S. publication no. 2011-0035328-A1, published Feb. 10, 2011, filed Jul. 15, 2010, and entitled “Methods, Apparatus, and Systems for Generating Technician Checklists for Locate and/or Marking Operations;”

U.S. publication no. 2011-0035252-A1, published Feb. 10, 2011, filed Jul. 15, 2010, and entitled “Methods, Apparatus, and Systems for Processing Technician Checklists for Locate and/or Marking Operations;”

U.S. publication no. 2011-0035324-A1, published Feb. 10, 2011, filed Jul. 15, 2010, and entitled “Methods, Apparatus, and Systems for Generating Technician Workflows for Locate and/or Marking Operations;”

U.S. publication no. 2011-0035245-A1, published Feb. 10, 2011, filed Jul. 15, 2010, and entitled “Methods, Apparatus, and Systems for Processing Technician Workflows for Locate and/or Marking Operations;”

U.S. publication no. 2011-0035260-A1, published Feb. 10, 2011, filed Jul. 15, 2010, and entitled “Methods, Apparatus, and Systems for Quality Assessment of Locate and/or Marking Operations Based on Process Guides;”

U.S. publication no. 2010-0256863-A1, published Oct. 7, 2010, filed Apr. 2, 2010, and entitled “Methods, Apparatus, and Systems for Acquiring and Analyzing Vehicle Data and Generating an Electronic Representation of Vehicle Operations;”

U.S. publication no. 2011-0022433-A1, published Jan. 27, 2011, filed Jun. 24, 2010, and entitled “Methods and Apparatus for Assessing Locate Request Tickets;”

U.S. publication no. 2011-0040589-A1, published Feb. 17, 2011, filed Jul. 21, 2010, and entitled “Methods and Apparatus for Assessing Complexity of Locate Request Tickets;”

U.S. publication no. 2011-0046993-A1, published Feb. 24, 2011, filed Jul. 21, 2010, and entitled “Methods and Apparatus for Assessing Risks Associated with Locate Request Tickets;”

U.S. publication no. 2011-0046994-A1, published Feb. 17, 2011, filed Jul. 21, 2010, and entitled “Methods and Apparatus for Multi-Stage Assessment of Locate Request Tickets;”

U.S. publication no. 2011-0040590-A1, published Feb. 17, 2011, filed Jul. 21, 2010, and entitled “Methods and Apparatus for Improving a Ticket Assessment System;”

U.S. publication no. 2011-0020776-A1, published Jan. 27, 2011, filed Jun. 25, 2010, and entitled “Locating Equipment for and Methods of Simulating Locate Operations for Training and/or Skills Evaluation;”

U.S. publication no. 2010-0285211-A1, published Nov. 11, 2010, filed Apr. 21, 2010, and entitled “Method Of Using Coded Marking Patterns In Underground Facilities Locate Operations;”

U.S. publication no. 2011-0137769-A1, published Jun. 9, 2011, filed Nov. 5, 2010, and entitled “Method Of Using Coded Marking Patterns In Underground Facilities Locate Operations;”

U.S. publication no. 2009-0327024-A1, published Dec. 31, 2009, filed Jun. 26, 2009, and entitled “Methods and Apparatus for Quality Assessment of a Field Service Operation;”

U.S. publication no. 2010-0010862-A1, published Jan. 14, 2010, filed Aug. 7, 2009, and entitled, “Methods and Apparatus for Quality Assessment of a Field Service Operation Based on Geographic Information;”

U.S. publication No. 2010-0010863-A1, published Jan. 14, 2010, filed Aug. 7, 2009, and entitled, “Methods and Apparatus for Quality Assessment of a Field Service Operation Based on Multiple Scoring Categories;”

U.S. publication no. 2010-0010882-A1, published Jan. 14, 2010, filed Aug. 7, 2009, and entitled, “Methods and Apparatus for Quality Assessment of a Field Service Operation Based on Dynamic Assessment Parameters;”

U.S. publication no. 2010-0010883-A1, published Jan. 14, 2010, filed Aug. 7, 2009, and entitled, “Methods and Apparatus for Quality Assessment of a Field Service Operation Based on Multiple Quality Assessment Criteria;”

U.S. publication no. 2011-0007076-A1, published Jan. 13, 2011, filed Jul. 7, 2010, and entitled, “Methods, Apparatus and Systems for Generating Searchable Electronic Records of Underground Facility Locate and/or Marking Operations;”

U.S. publication no. 2011-0131081-A1, published Jun. 2, 2011, filed Oct. 29, 2010, and entitled “Methods, Apparatus, and Systems for Providing an Enhanced Positive Response in Underground Facility Locate and Marking Operations;”

U.S. publication no. 2011-0060549-A1, published Mar. 10, 2011, filed Aug. 13, 2010, and entitled, “Methods and Apparatus for Assessing Marking Operations Based on Acceleration Information;”

U.S. publication no. 2011-0117272-A1, published May 19, 2011, filed Aug. 19, 2010, and entitled, “Marking Device with Transmitter for Triangulating Location During Locate Operations;”

U.S. publication no. 2011-0045175-A1, published Feb. 24, 2011, filed May 25, 2010, and entitled, “Methods and Marking Devices with Mechanisms for Indicating and/or Detecting Marking Material Color;”

U.S. publication no. 2010-0088135 A1, published Apr. 8, 2010, filed Oct. 1, 2009, and entitled, “Methods and Apparatus for Analyzing Locate and Marking Operations with Respect to Environmental Landmarks;”

U.S. publication no. 2010-0085185 A1, published Apr. 8, 2010, filed Sep. 30, 2009, and entitled, “Methods and Apparatus for Generating Electronic Records of Locate Operations;”

U.S. publication no. 2011-0095885 A9 (Corrected Publication), published Apr. 28, 2011, and entitled, “Methods And Apparatus For Generating Electronic Records Of Locate Operations;”

U.S. publication no. 2010-0090700-A1, published Apr. 15, 2010, filed Oct. 30, 2009, and entitled “Methods and Apparatus for Displaying an Electronic Rendering of a Locate Operation Based on an Electronic Record of Locate Information;”

U.S. publication no. 2010-0085054 A1, published Apr. 8, 2010, filed Sep. 30, 2009, and entitled, “Systems and Methods for Generating Electronic Records of Locate And Marking Operations;” and

U.S. publication no. 2011-0046999-A1, published Feb. 24, 2011, filed Aug. 4, 2010, and entitled, “Methods and Apparatus for Analyzing Locate and Marking Operations by Comparing Locate Information and Marking Information.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The drawings are not necessarily to scale, emphasis instead generally being placed upon illustrating the principles of the invention.

FIG. 1 shows an example in which a locate and marking operation is initiated as a result of an excavator providing an excavation notice to a one-call center.

FIG. 2 illustrates one example of a conventional locate instrument set including a locate transmitter and a locate receiver.

FIGS. 3A and 3B illustrate a conventional marking device in an actuated and non-actuated state, respectively.

FIG. 4A shows a perspective view of an example of an imaging-enabled marking device that has a camera system and image analysis software for performing marking material color detection, according to some embodiments of the present disclosure.

FIG. 4B illustrates a block diagram for an example of a camera system, according to one embodiment of the present disclosure.

FIG. 5 illustrates an example of control electronics of an imaging-enabled marking device, according to some embodiments of the present disclosure.

FIG. 6A illustrates an example of a frame of image data that shows a target surface with no markings thereon, according to some embodiments of the present disclosure.

FIG. 6B illustrates an example of a frame of image data that shows a target surface with fresh markings thereon, according to some embodiments of the present disclosure.

FIG. 7A illustrates a flow diagram of an example of a method of determining a marking material color, according to some embodiments of the present disclosure.

FIG. 7B illustrates a flow diagram of an example of a method of determining a marking material color, according to some embodiments of the present disclosure.

FIG. 7C illustrates a flow diagram of an example of a method of determining a marking material color by processing one or more frames of image data, according to some embodiments of the present disclosure.

FIG. 8 illustrates a flow diagram of an example of a method of determining a marking material color by performing a pixel intensity analysis, according to some embodiments of the present disclosure.

FIG. 9 illustrates a functional block diagram of an example of a locate operations system that includes a network of one or more imaging-enabled marking devices, according to some embodiments of the present disclosure.

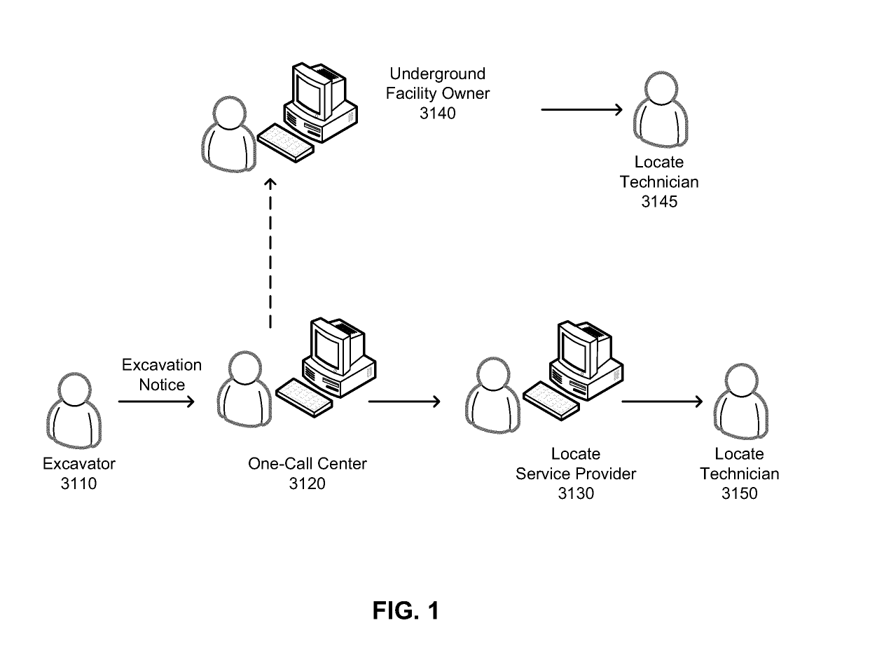

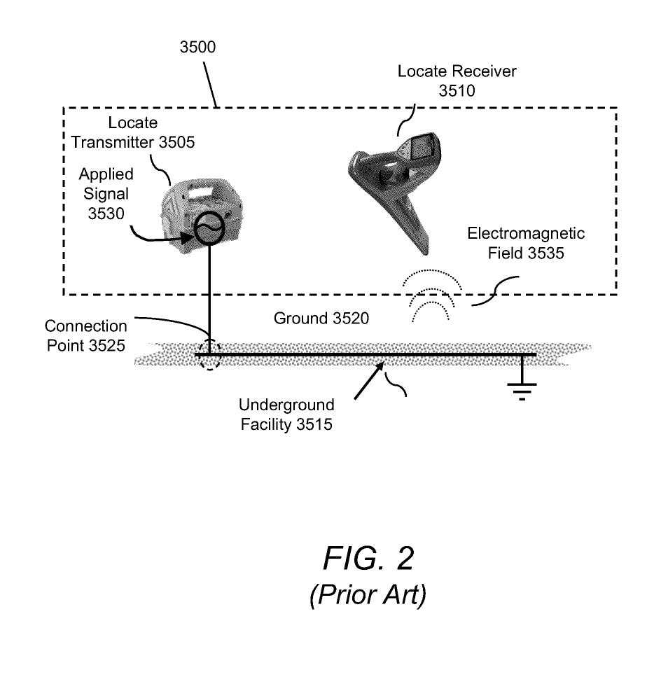

### DETAILED DESCRIPTION

Applicants have recognized and appreciated that uncertainties which may be attendant to locate and marking operations may be significantly reduced by collecting various information particularly relating to the marking operation, rather than merely focusing on information relating to detection of underground facilities via a locate device. Furthermore, the location at which an underground facility ultimately is detected during a locate operation is not always where the technician physically marks the ground, pavement or other surface during a marking operation. Accordingly, having documentation (e.g., an electronic record) of where physical locate marks were actually dispensed (i.e., what an excavator encounters when arriving to a work site) is notably more relevant to the assessment of liability in the event of damage and/or injury than where an underground facility was detected prior to marking.

Applicants have also recognized and appreciated that building a more comprehensive electronic record of information relating to marking operations further facilitates ensuring the accuracy of such operations. For example, collecting and analyzing information relating to a color of a marking material being applied may facilitate ensuring accuracy of locate and marking operations. Such information may be reviewed and evaluated by supervisory personnel to determine whether a locate technician has properly performed a locate and marking operation. For instance, the supervisory personnel may check whether the color of the marking material applied by the locate technician correctly corresponds to a type of detected underground facilities. An observed discrepancy may trigger some appropriate corrective action, such as a re-mark operation (e.g., dispatching the same technician or a different technician to the work site to repeat part or all of the locate and marking operation) and/or recommendation for further training for the locate technician.

In some instances, the information collected during the marking operation may also be examined by a regulator and/or an insurer for auditing purposes (e.g., to verify whether the locate and marking operation has been proper conducted). As another example, the electronic record may be analyzed during damage investigation in the event of an accident during subsequent excavation (e.g., as evidence that a certain type of marking material was dispensed at a certain location).

Accordingly, in some embodiments, systems methods, and apparatus are provided for determining a color of marking material dispensed by a marking device onto a surface to mark a presence or an absence of at least one underground facility within a dig area that is planned to be excavated or disturbed during excavation activities. For example, one or more image acquisition devices (e.g., digital video cameras) may be mounted on a marking device to capture images of the surface being marked. The cameras may be mounted near a nozzle of a marking material dispenser, so as to capture images of freshly dispensed marking material on the surface being marked. The captured images may then be analyzed to determine a color of the freshly dispensed marking material, which may be correlated with a type of facilities being marked.

Following below are more detailed descriptions of various concepts related to, and embodiments of, inventive systems, methods and apparatus for marking material color detection in connection with locate and marking operations. It should be appreciated that various concepts introduced above and discussed in greater detail below may be implemented in any of numerous ways, as the disclosed concepts are not limited to any particular manner of implementation. Examples of specific implementations and applications are provided solely for illustrative purposes.

In some illustrative embodiments, a marking device is provided that has a camera system and image analysis software (hereafter called imaging-enabled marking device) for performing marking material color detection. The image analysis software may alternatively be remote from the marking device and operate on data uploaded from the marking device, either contemporaneously to collection of the data or at a later time.

For purposes of the present disclosure, it should be appreciated that the terminology “camera system” refers generically to any one or more components that facilitate acquisition of image and/or color data relevant to the determination of marking material color; in particular, the term “camera system” as used herein is not necessarily limited to conventional camera or video devices (e.g., digital cameras or video recorders) that capture images of the environment, but may also or alternatively refer to any of a number of sensing and/or processing components (e.g., semiconductor chips or sensors that detect color or color components without necessarily acquiring an image), alone or in combination with other components (e.g., semiconductor sensors alone or in combination with conventional image acquisition devices or imaging optics), that facilitate acquisition of image and/or color data relevant to the determination of marking material color. Similarly, the term “image analysis software” relates generically to processor-executable instructions that, when executed by one or more processing units (e.g., included as part of control electronics of a marking device, as discussed further below), process image-related and/or color-related data, and in some instance additional information (e.g., relating to a motion of the marking device), to facilitate a determination of marking material color.

More specifically, in some illustrative embodiments, the imaging-enabled marking device includes certain image analysis software that may execute any one or more algorithms that are useful for automatically determining a color of a marking material that is being dispensed to mark a presence or absence of an underground facility. Examples of marking materials include, but are not limited to, paint, chalk, dye, and marking powder. With respect to performing underground facilities locate operations, an example of the correlation of marking material color to the type of facilities being marked is indicated in Table 1 below.

TABLE 1
Correlation of color to facility type

| Marking | |
|---|---|
| material color | Facility Type |
| White | Proposed excavation |
| Pink | Temporary survey markings |
| Red | Electric power lines, cables or conduits, and lighting cables |
| Yellow | Gas, oil, steam, petroleum, or other hazardous liquid or |
| | gaseous materials |
| Orange | Communications, cable TV, alarm or signal lines, cables, |
| | or conduits |
| Blue | Water, irrigation, and slurry lines |
| Purple | Reclaimed water, irrigation and slurry lines |
| Green | Sewers, storm sewer facilities, or other drain lines |
| Black | Mark-out for errant lines |

In certain embodiments, the camera system may include one or more digital video cameras. In one example, the process of automatically determining a marking material color may be based, at least in part, on sensing motion of the imaging-enabled marking device. That is, in one exemplary implementation, any time that imaging-enabled marking device is in motion, at least one digital video camera may be activated and image processing may occur to process information provided by the video camera(s) to facilitate determination of marking material color. In other embodiments, as an alternative to or in addition to one or more digital video cameras, the camera system may include one or more digital still cameras, and/or one or more semiconductor-based sensors or chips (e.g., color sensors, light sensors, optical flow chips) to provide various types of camera system data (e.g., including one or more of image information, non-image information, color information, light level information, motion information, etc.) relating to a surface onto which a certain color of marking material may be disposed.

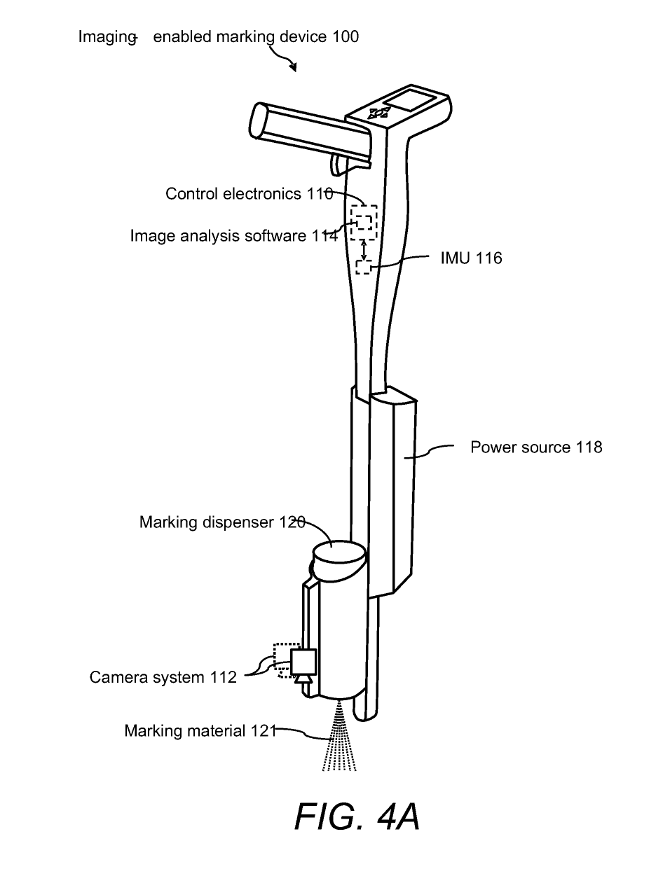

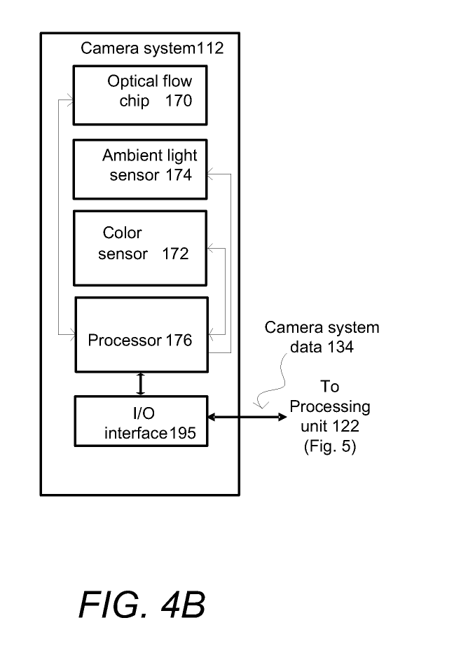

Referring to FIG. 4A, a perspective view of an example of an imaging-enabled marking device 100 that includes one or more camera systems and image analysis software for performing marking material color detection is presented. More specifically, FIG. 4A shows an imaging-enabled marking device 100 that is an electronic marking device capable of creating electronic records of locate operations, wherein the marking device includes a camera system and is configured to execute image analysis software to facilitate color detection.

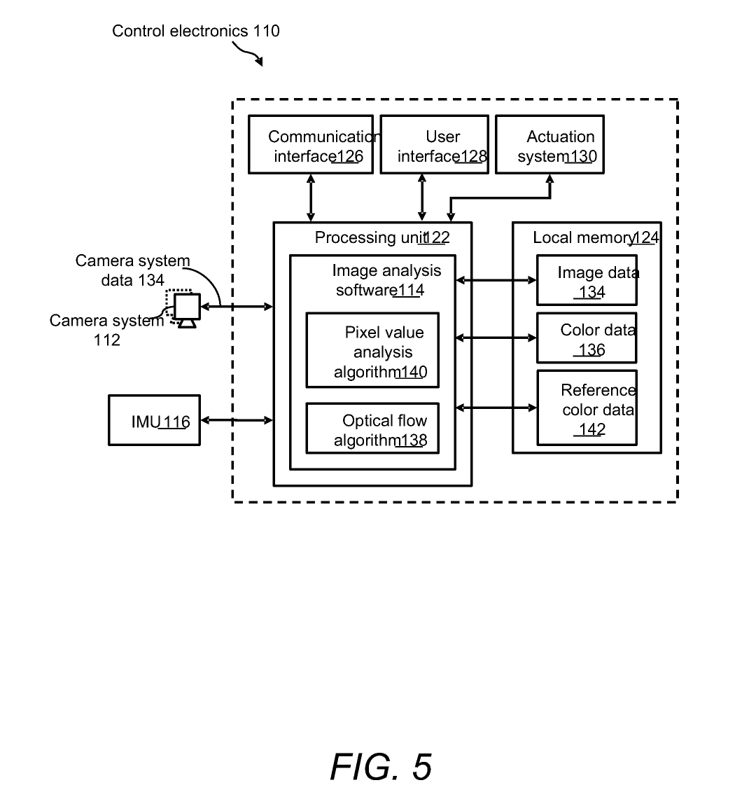

In one example, imaging-enabled marking device 100 may include certain control electronics 110 and one or more camera systems 112. The control electronics 110 may be used for managing the overall operations of the imaging-enabled marking device 100. Additional details of an example of the control electronics 110 are described with reference to FIG. 5.

As noted above, the one or more camera systems 112 may include any one or more of a variety of components to facilitate acquisition and/or provision of “camera system data” to the control electronics 110 of the marking device 100 (e.g., to be processed by image analysis software 114, discussed further below). The camera system data ultimately provided by camera system(s) 112 generally may include any type of information relating to a surface onto which marking material may be disposed, including information relating to marking material already disposed on the surface. Accordingly, it should be appreciated that such information constituting camera system data may include, but is not limited to, image information, non-image information, color information, surface type information, and light level information. To this end, the camera system 112 may include any of a variety of conventional cameras (e.g., digital still cameras, digital video cameras), special purpose cameras or other image-acquisition devices (e.g., infra-red cameras), as well as a variety of respective components (e.g., semiconductor chips and/or sensors relating to acquisition of image-related data and/or color-related data), used alone or in combination with each other, to provide information (e.g., camera system data) to be processed by the image analysis software 114.

FIG. 4B illustrates a block diagram of one example of a camera system 112, according to one embodiment of the present invention. The camera system 112 of this embodiment may include one or more “optical flow chips” 170, one or more color sensors 172, one or more ambient light sensors 174, one or more controllers and/or processors 176, and one or more input/output (I/O) interfaces 195 to communicatively couple the camera system 112 to the control electronics 110 of the marking device 100 (e.g., and, more particularly, the processing unit 122). As illustrated in FIG. 4B, each of the optical flow chip(s), the color sensor(s), the ambient light sensor(s), and the I/O interface(s) may be coupled to the controller(s)/processors, wherein the controller(s)/processor(s) are configured to receive information provided by one or more of the optical flow chip(s), the color sensor(s), and the ambient light sensor(s), in some cases process and/or reformat all or part of the received information, and provide all or part of such information, via the I/O interface(s), to the control electronics 110 (e.g., processing unit 122) as camera system data 134. While FIG. 4B illustrates each of an optical flow chip, a color sensor and an ambient light sensor, it should be appreciated that, in other embodiments, each of these components is not necessarily required in a camera system as contemplated according to the concepts disclosed herein. For example, in one embodiment, the camera system 112 may be as simple as a color sensor 172 mounted in an appropriate manner to the marking device 100 and communicatively coupled to the processing unit 122 to provide color information as the camera system data 134. In yet another embodiment, the camera system may include only an optical flow chip 170 to provide one or more of color information, image information, and motion information.

In one exemplary implementation of the camera system 112 shown in the embodiment of FIG. 4B, the optical flow chip 170 includes an image acquisition device and may measure changes in position of the chip (i.e., as mounted on the marking device) by optically acquiring sequential images and mathematically determining the direction and magnitude of movement. Exemplary optical flow chips may acquire images at up to 6400 times per second at a maximum of 1600 counts per inch (cpi), at speeds up to 40 inches per second (ips) and acceleration up to 15 g. The optical flow chip may operate in one of two modes: 1) gray tone mode, in which the images are acquired as gray tone images, and 2) color mode, in which the images are acquired as color images. In some embodiments, the optical flow chip may operate in color mode and obviate the need for a separate color sensor, similarly to various embodiments employing a digital video camera (as discussed in greater detail below). In other embodiments, the optical flow chip may be used to provide information relating to whether the marking device is in motion or not.

Similarly, in one implementation of the camera system 112 shown in FIG. 4B, an exemplary color sensor 172 may combine a photodiode, color filter, and transimpedance amplifier on a single die. In this example, the output of the color sensor may be in the form of an analog signal and provided to an analog-to-digital converter (e.g., as part of the processor 176, or as dedicated circuitry not specifically shown in FIG. 4B) to provide one or more digital values representing color. In another example, the color sensor 172 may be an integrated light-to-frequency converter (LTF) that provides RGB color sensing that is performed by a photodiode grid including 16 groups of 4 elements each. In this example, the output for each color may be a square wave whose frequency is directly proportional to the intensity of the corresponding color. Each group may include a red sensor, a green sensor, a blue sensor, and a clear sensor with no filter. Since the LTF provides a digital output, the color information may be input directly to the processor 176 by sequentially selecting each color channel, then counting pulses or timing the period to obtain a value. In one embodiment, the values may be sent to processor 176 and converted to digital values which are provided to the control electronics 110 of the marking device (e.g., the processing unit 122) via I/O interface 195.

An exemplary ambient light sensor 174 of the camera system 112 shown in FIG. 4B may include a silicon NPN epitaxial planar phototransistor in a miniature transparent package for surface mounting. The ambient light sensor 174 may be sensitive to visible light much like the human eye and have peak sensitivity at, e.g., 570 nm. The ambient light sensor provides information relating to relative levels of ambient light in the area targeted by the positioning of the marking device.

An exemplary processor 176 of the camera system 112 shown in FIG. 4B may include an ARM based microprocessor such as the STM32F103, available from STMicroelectronics (see: http://www.st.com/internet/mcu/class/1734.jsp), or a PIC 24 processor (for example, PIC24FJ256GA106-I/PT from Microchip Technology Inc. of Chandler, Ariz.). The processor may be configured to receive data from one or more of the optical flow chip(s) 170, the color sensor(s) 172, and the ambient light sensor(s) 174, in some instances process and/or reformat received data, and to communicate with the processing unit 122.

An I/O interface 195 of the camera system 112 shown in FIG. 4B may be one of various wired or wireless interfaces such as those discussed further below with respect to communications interface 126 of FIG. 5. For example, in one implementation, the I/O interface may include a USB driver and port for providing data from the camera system 112 to processing unit 122.

In one exemplary implementation based on the camera system outlined in FIG. 4B, the one or more optical flow chips may be selected as the ADNS-3080 chip available from Avago Technologies (e.g., see http://www.avagotech.com/pages/en/navigation_interface_devices/navigation_sensors/led-based_sensors/adns-3080/). The one or more color sensors may be selected as the TAOS TCS3210 sensor available from Texas Advanced Optoelectronic Solutions (TAOS) (see http://www.taosinc.com/). The one or more ambient light sensors may be selected as the Vishay part TEMT6000 (e.g., see http://www.vishay.com/product?docid=81579). As discussed further below in connection with implementations involving one or more of an optical flow chip, a color sensor and an ambient light sensor, detection of a marking material color may or may not rely on a concurrent detection of motion of the marking device according to different embodiments.

With reference again to FIG. 4A, the camera system 112 may alternatively or additionally include one or more standard digital video cameras that have a frame rate and resolution that is suitable for use in the imaging-enabled marking device 100. In one aspect, each digital video camera may be a universal serial bus (USB) digital video camera. In one example, each digital video camera may be a Sony PlayStation®Eye video camera that has a 10-inch focal length and is capable of capturing 60 frames/second, where each frame is, for example, 640×480 pixels. An alternative example may use a camera such as the Toshiba TCM8230MD. In the example of the Sony PlayStation®Eye video camera, a suitable placement of each digital video camera on the imaging-enabled marking device 100 may be about 10 to 13 inches from a surface to be marked, when the marking device 100 is held by a technician during normal use. Each digital video camera may be mounted on the imaging-enabled marking device 100 in such a manner and/or at such a location that marking material, once dispensed on a target surface, is within some desired portion of the camera's field of view (FOV). In one example, the digital output of the one or more digital video cameras may be stored in any standard and/or proprietary video file format, such as an Audio Video Interleave (.AVI) format or a QuickTime (.QT) format. In another example, only certain frames of the digital output of the one or more digital video cameras (e.g., every n^{th} frame, such as every 5^{th}, 10^{th}, 20^{th} frame) may be stored.

Certain image analysis software 114 may reside at and execute on the control electronics 110 of the imaging-enabled marking device 100. In one embodiment, the image analysis software 114 may be any suitable image analysis software for processing digital video output (e.g., from at least one digital video camera). In other embodiments, as noted above, the image analysis software 114 may be configured to process information provided by one or more components such as color sensors, ambient light sensors, and/or optical flow chips/sensors. In some implementations, the image analysis software 114 may include one or more algorithms, such as, but not limited to, an optical flow algorithm and/or a pixel value analysis algorithm. Additional details of examples of algorithms that may be implemented in the image analysis software 114 are described with reference to FIGS. 5 through 9.

The imaging-enabled marking device 100 may include one or more devices that may be useful in combination with the camera system(s) 112 and the image analysis software 114. For example, the imaging-enabled marking device 100 may include an inertial measurement unit (IMU) 116. The IMU 116 is an example of a mechanism by which the image analysis software 114 may sense that the imaging-enabled marking device 100 is in motion. The aforementioned optical flow algorithm is another example of a mechanism by which the image analysis software 114 may sense motion.

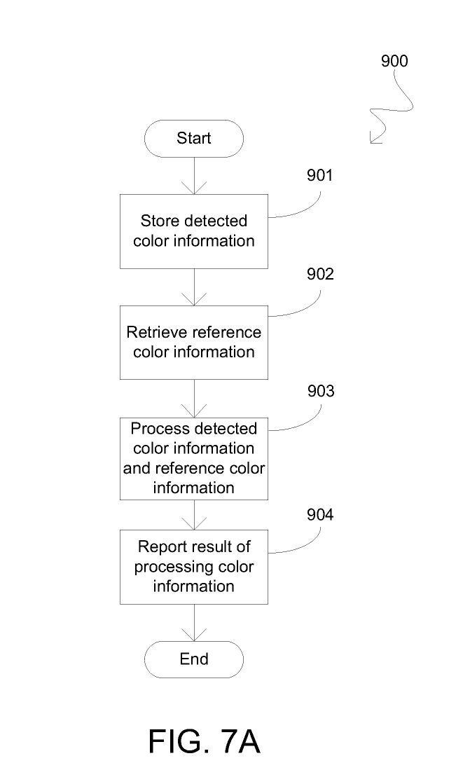

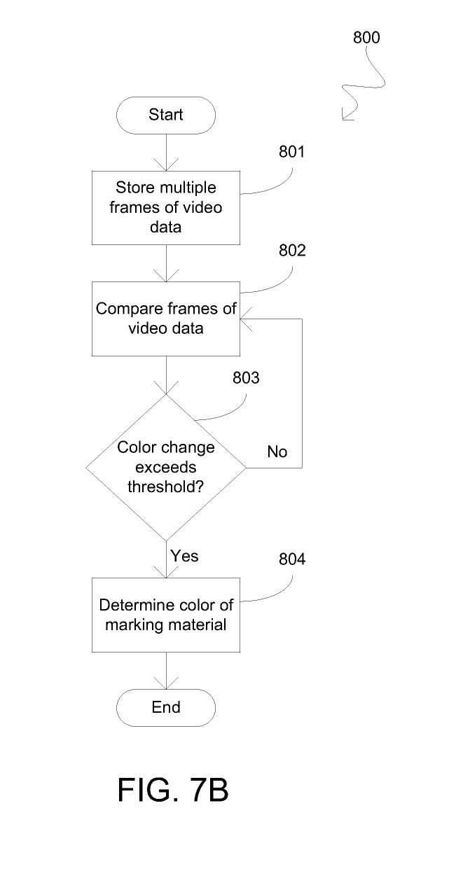

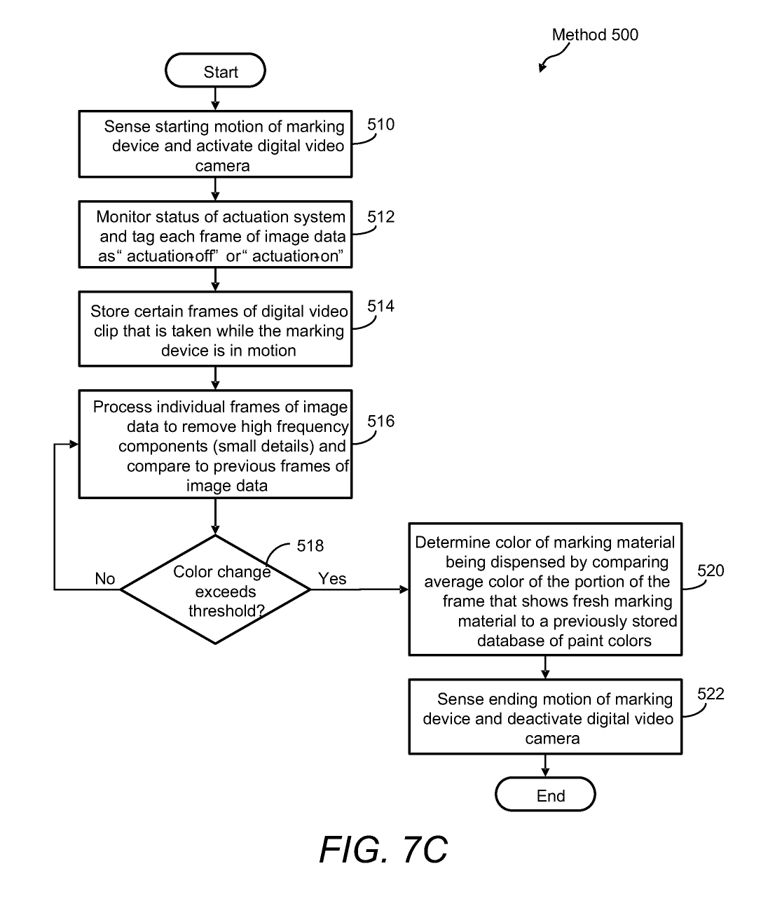

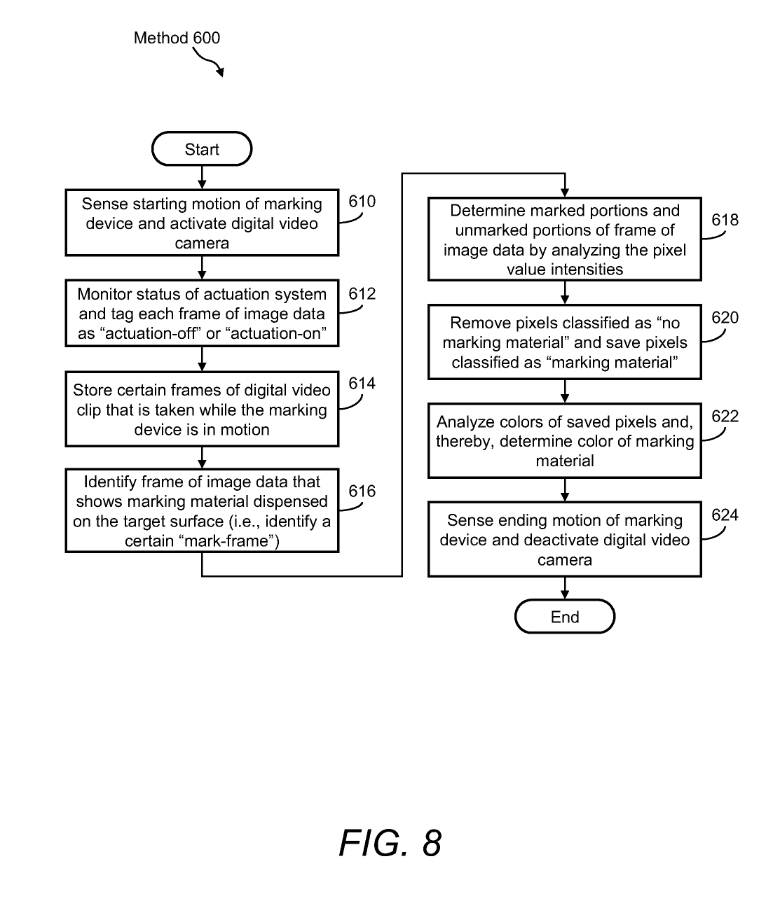

An IMU is an electronic device that measures and reports an object's acceleration, orientation, and/or gravitational forces by use of one or more inertial sensors, such as one or more accelerometers, gyroscopes, and/or compasses. The IMU 116 may be any commercially available IMU device for reporting the acceleration, orientation, and/or gravitational forces of any device in which it is installed. In one example, the IMU 116 may be an IMU 6 Degrees of Freedom (6DOF) device, which is available from SparkFun Electronics (Boulder, Colo.). This SparkFun IMU 6DOF device has Bluetooth® capability and provides 3 axes of acceleration data, 3 axes of gyroscopic data, and 3 axes of magnetic data. Readings from the IMU 116 may be a useful input to one or more processes of the image analysis software 114, as described with reference to the methods of FIGS. 7 and 8.

The components of the imaging-enabled marking device 100 may be powered by a power source 118. The power source 118 may be any power source that is suitable for use in a portable device, such as, but not limited to, one or more rechargeable batteries, one or more non-rechargeable batteries, a solar electrovoltaic panel, a standard AC power plug feeding an AC-to-DC converter, and the like.

Referring again to FIG. 4A, a marking dispenser 120 (e.g., an aerosol marking paint canister) may be installed in the imaging-enabled marking device 100. Marking material 121 may be dispensed from the marking dispenser 120. Examples of marking materials include, but are not limited to, paint, chalk, dye, and marking powder.

In the embodiment illustrated in FIG. 4A, the one or more camera systems 112 are mounted at a portion of imaging-enabled marking device 100 that is near the marking dispenser 120. This mounting position may be desirable for two reasons: (1) the motion of the one or more camera systems 112 may match the motion of the tip of the imaging-enabled marking device 100 where the marking material 121 is dispensed, and (2) a portion of the marking material 121 that is dispensed onto a target surface may be in a field of view (FOV) of the one or more camera systems 112.

Referring to FIG. 5, a functional block diagram of an example of the control electronics 110 of the imaging-enabled marking device 100 of the present disclosure is presented. In this example, the control electronics 110 includes the image analysis software 114 shown in FIG. 4A, a processing unit 122, a quantity of local memory 124, a communication interface 126, a user interface 128, and an actuation system 130. However, it should be appreciated that the control electronics 110 is not limited to these exemplary components, nor to the exemplary configuration shown in FIG. 5.

The image analysis software 114 may be programmed into the processing unit 122. The processing unit 122 may be any general-purpose processor, controller, or microcontroller device that is capable of managing the overall operations of the imaging-enabled marking device 100, including managing data that is returned from any component thereof. The local memory 124 may be any volatile or non-volatile data storage device, such as, but not limited to, a random access memory (RAM) device and a removable memory device (e.g., a USB flash drive).

The communication interface 126 may be any wired and/or wireless communication interface for connecting to a network (e.g., a local area network such as an enterprise intranet, a wide area network, or the Internet) and by which information (e.g., the contents of the local memory 124) may be exchanged with other devices connected to the network. Examples of wired communication interfaces may be implemented according to various interface protocols, including, but not limited to, USB protocols, RS232 protocol, RS422 protocol, IEEE 1394 protocol, Ethernet protocols, optical protocols (e.g., relating to communications over fiber optics), and any combinations thereof. Examples of wireless communication interfaces may be implemented according to various wireless technologies, including, but not limited to Bluetooth®, ZigBee®, Wi-Fi/IEEE 802.11, Wi-Max, various cellular protocols, Infrared Data Association (IrDA) compatible protocols, Shared Wireless Access Protocol (SWAP), and any combinations thereof.

The user interface 128 may be any mechanism or combination of mechanisms by which a user may operate the imaging-enabled marking device 100 and by which information that is generated by the imaging-enabled marking device 100 may be presented to the user. For example, the user interface 128 may include, but is not limited to, a display, a touch screen, one or more manual pushbuttons, one or more light-emitting diode (LED) indicators, one or more toggle switches, a keypad, an audio output (e.g., speaker, buzzer, and alarm), a wearable interface (e.g., data glove), and any combinations thereof.

The actuation system 130 may include a mechanical and/or electrical actuator mechanism (not shown) that may be coupled to an actuator that causes the marking material to be dispensed from the marking dispenser of the imaging-enabled marking device 100. Actuation refers to starting or causing the imaging-enabled marking device 100 to work, operate, and/or function. Examples of actuation include, but are not limited to, any local, remote, physical, audible, inaudible, visual, non-visual, electronic, electromechanical, biomechanical, and biosensing signals, instructions, and events. Actuations of the imaging-enabled marking device 100 may be performed for any purpose, such as, but not limited to, dispensing marking material and capturing any information of any component of the imaging-enabled marking device 100 without dispensing marking material. In one example, an actuation may occur by pulling or pressing a physical trigger of the imaging-enabled marking device 100 that causes the marking material to be dispensed.

FIG. 5 also shows one or more camera systems 112 connected to the control electronics 110 of the imaging-enabled marking device 100. In particular, camera system data 134 from the camera system 112 may be passed (e.g., frame by frame, in the case of video information) to the processing unit 122 and processed by the image analysis software 114. In one example relating to processing of video information, every n^{th} frame (e.g., every 5^{th}, 10^{th} or 20^{th} frame) of the camera system data 134 may be processed and stored in the local memory 124. In this way, the processing capability of the processing unit 122 may be improved. FIG. 5 shows that the image analysis software 114 may include one or more algorithms, which may be any task-specific algorithms with respect to processing the information provided by the camera system 112 for determining a color of a marking material being dispensed. The results of executing the operations of the image analysis software 114 may be compiled into color data 136, which may also be stored in the local memory 124. Examples of these task-specific algorithms that may be programmed into the image analysis software 114 include, but are not limited to, an optical flow algorithm 138 and a pixel value analysis algorithm 140. In embodiments including a color sensor that outputs a detected color value directly, the image analysis software 114 may include receiving the detected color value 136 and storing it in memory 124.

In some embodiments, the operation of the camera system 112 and associated operations of the image analysis software 114 may be started and stopped by any mechanisms, such as manually by the user and/or automatically by programming. In yet another example, once processes of the image analysis software 114 are initiated, the image analysis software may be programmed to run for a certain amount of time (e.g., a few seconds). In any case, once the camera system 112 is activated in some embodiments, the image analysis software 114 may be programmed to process every n^{th} frame (e.g., every 5^{th}, 10^{th} or 20^{th} frame) of the camera system data 134.

In one embodiment, the camera system 112 may be activated only when it is sensed that the imaging-enabled marking device 100 is in motion. In this example, the processing unit 122 may query readings from the IMU 116 to determine whether the imaging-enabled marking device 100 is in motion. Additionally, or alternatively, the processing unit 122 may query the output of the optical flow algorithm 138 that is used to process the camera system data 134 from at least one camera system 112 to determine whether the imaging-enabled marking device 100 is in motion. In yet another embodiment, the camera system 112 itself may include an optical flow chip, and the camera system data 134 may include information relating to motion as provided by the optical flow chip of the camera system 112.

In alternative embodiments, the imaging-enabled marking device may receive camera system data on an ongoing basis, without regard to whether or not the imaging-enabled marking device is in motion. For example, in embodiments where an optical flow chip and a color sensor are used in the camera system instead of digital video cameras, the camera system may draw less power, making it practical to operate the camera system continuously.

The optical flow algorithm 138 is used for performing an optical flow calculation, which is well known, for determining a pattern of apparent motion of at least one camera system 112, thereby determining a pattern of apparent motion of the imaging-enabled marking device 100. In one example, the optical flow algorithm 138 uses the Pyramidal Lucas-Kanade method for performing the optical flow calculation. An optical flow calculation may include a process of identifying features (or groups of features) that occur in at least two frames of image data (e.g., at least two frames of the camera system data 134) and, therefore, can be tracked from frame to frame. Then the optical flow algorithm 138 compares the xy position (in pixels) of the common features in the at least two frames and determine the change (or offset) in xy position from one frame to the next as well as the direction of the change. Then the optical flow algorithm 138 generates a velocity vector for each common feature, which represents the movement of the feature from one frame to the next frame. Therefore, the optical flow algorithm 138 provides a mechanism by which the processing unit 122 may determine whether the imaging-enabled marking device 100 is in motion.

The pixel value analysis algorithm 140 may be used to determine the red, green, and blue (RGB) color distribution in any frame of the camera system data 134 from any camera system 112, where each frame of the camera system data 134 may contain an image of a target surface (with or without marking material present). Alternatively, a color sensor may be used, which may output a single color value, e.g., an RGB triplet. It is known in the art to use RGB data of various sizes. One exemplary embodiment employs one byte of data for each of the three color channels in an RGB triplet, for a total of 256 possible values for each of the three color channels. For example, a word of data stored in memory may have the value 0xFF8000, which may indicate a color having a red channel value of 0xFF (i.e., maximum red value), a green channel value of 0x80, and a blue channel value of 0x00 (i.e., minimum blue value). The color sensor may also determine an intensity value. An ambient light sensor also may be used to provide a measurement of the ambient light level. The ambient light sensor may provide an analog signal that is converted to a digital signal by processor 176 or by an optional on-board A/D converter (not shown). The digital signal may be formatted in any appropriate format for further processing by processing unit 122, such as a percentage of full brightness, or a one or more byte value representing a range from a minimum detectable brightness to a maximum detectable brightness.

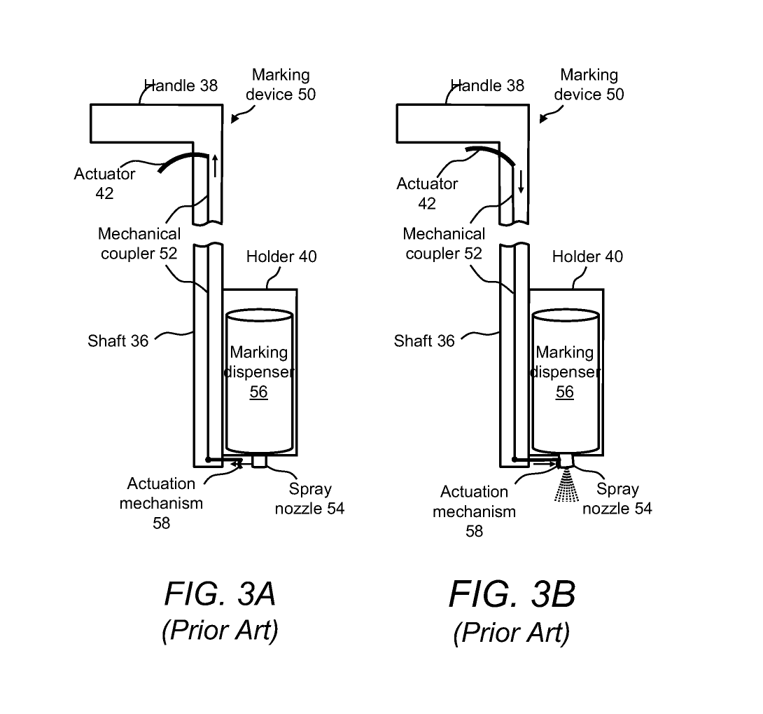

Furthermore, in embodiments involving one or more “frames” or still or video digital image information provided in the camera system data 134, the pixel value analysis algorithm 140 may be used to compare the RGB color distribution of a frame (or portions thereof) of the camera system data 134 that shows the target surface with no markings thereon to the RGB color distribution of a frame (or portions thereof) of the camera system data 134 that shows the target surface with fresh markings thereon. For example, in some embodiments, the pixel value analysis algorithm 140 may be used to compare a first image taken when the actuation system 130 is in a non-actuated state (e.g., when a trigger is in a released position as shown in FIG. 3A) with a second image taken when the actuation system 130 is in an actuated state (e.g., when a trigger is held by a user in a pulled position as shown in FIG. 3B). As a more specific example, the first image may be taken a short time (e.g., one or two seconds) before the actuation system 130 is first actuated to dispense marking material, and the second image may be taken a short time (e.g., one or two seconds) after the actuation system 130 is first actuated to dispense marking material, so that there is a high likelihood that the second image would contain marking material freshly dispensed on a surface similar to the surface captured in the first image, provided the imaging-enabled marking device 100 is functioning as expected.

If a certain amount of color change is detected between two such image frames, it may be determined that fresh marking material has been dispensed. The RGB color information of the fresh marking material may then be compared to, for example, reference color data 142 to determine a color of the marking material. For example, stored in the reference color data 142 may be records of color data for various marking material colors. Again, a color that is determined for the fresh marking material may be stored in the color data 136 of the local memory 124. More details of this process are described with reference to FIGS. 3 through 6.

It should be appreciated that the RGB color model is discussed herein solely for purposes of illustration. Image data may alternatively be stored and/or manipulated in accordance with any suitable color model other than the RGB model, such as the CMY (cyan, magenta, and yellow) model.

In addition to generating and analyzing RGB color distributions to determine marking material color, the pixel value analysis algorithm 140 may be used in another way to determine marking material color. For example, Applicants have recognized and appreciated that freshly applied marking materials (e.g., paint) may have certain characteristic intensities. Accordingly, in some embodiments, the pixel value analysis algorithm 140 may be used for analyzing pixel intensities that are in some manner represented in the camera system data 134 (e.g., for still or digital image information, in each frame of camera system data 134) in order to distinguish marked and unmarked portions of the frame, prior to determining a color of the marked portions. A predetermined intensity threshold selected according to the intensity of freshly dispensed marking material may be retrieved from the local memory 124 and may be used to determine whether a frame of the camera system data 134 contains an image of freshly dispensed marking material. Additional details of this process are described with reference to FIG. 8.

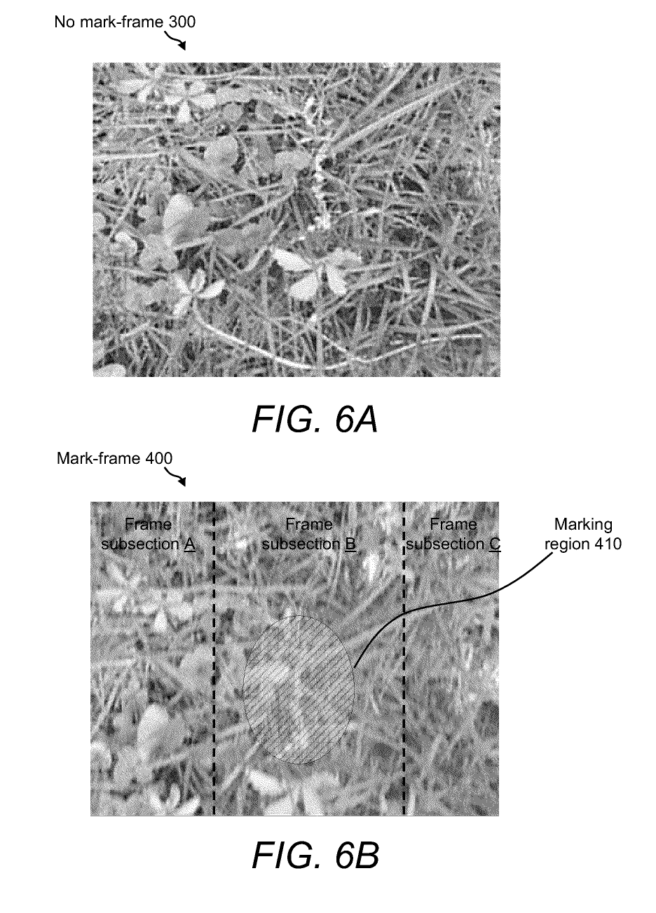

As discussed above, the camera system(s) 112 may be mounted on the imaging-enabled marking device 100 at such a location that freshly dispensed marking material can be expected at a known location in an image taken while the imaging-enabled marking device is actuated to dispense marking material. Accordingly, in alternative embodiments, the pixel value analysis algorithm may treat a portion of an image as an expected marked portion based on a mounting position of the digital video cameras 112. Color determination analysis may then be focused on the expected marked portion, thereby reducing the likelihood of incorrect color determination due to noise in the camera system data (e.g., previously dispensed marking material, or a colored object, adjacent to freshly dispensed marking material). An example of an expected marked portion is shown in FIG. 6B and described below.

Referring to FIG. 6A, an example of a frame of camera system data, including still or video digital image information that shows a target surface with no markings thereon, is presented. Such a frame of image data may be hereafter referred to as a “no mark-frame.” By way of example, FIG. 6A shows a no mark-frame 300 that is a frame of the camera system data 134 showing grass as the target surface. The no mark-frame 300 shows no marking material dispensed on the grass surface. The no mark-frame 300 may be, for example, a frame of the camera system data 134 captured just prior to an actuation-on event of the actuation system 130.

Referring to FIG. 6B, an example of a frame of image data that shows a target surface with fresh markings thereon is presented. Such a frame of image data may be hereafter referred to as a “mark-frame.” By way of example, FIG. 6B shows a mark-frame 400, which may be, for example, a frame of the camera system data 134 captured during an actuation-on event of actuation system 130. In this example, the mark-frame 400 is a frame of the camera system data 134 that shows grass as the target surface. The mark-frame 400 also shows a marking region 410, which is a portion of the frame that shows fresh marking material dispensed on the grass surface. As discussed above, because the position of camera system 112 may be relatively fixed with respect to a location of the marking material 121 that is being dispensed, the freshly dispensed marking material 121 may appear in a predictable location in each frame of the camera system data 134. Therefore, the location of marking region 410 within each frame of the camera system data 134 may be predictable. For example, the marking region 410 may be expected within a frame subsection B (e.g., the frame subsection B may be an expected marked portion of the frame). In the example shown in FIG. 6B, the color of the marking material on the grass surface and within marking region 410 is blue (shown as a hatched area).

Referring to FIG. 7A, a flow diagram of an example of a general method 900 for determining marking material color based at least in part on camera system data 134 is presented, according to one embodiment of the invention. In one exemplary implementation, the method 900 may be performed by the processing unit 122 of control electronics 110 of a marking device, executing one or more programs to process one or more of image data 134, color data 134, and reference color data 142 stored in local memory 124 of the control electronics 110. In some implementations, such programs may operate in tandem with, and/or utilize information provided in part by, operation of the image analysis software 114.

At step 901, detected color information, derived in some manner from the camera system data 134 (e.g., via the image analysis software 114), is stored (e.g., in local memory 124 of the control electronics 110 as color data 136). According to some embodiments, detected color information may be determined by analyzing frames of digital video data included in the camera system data 134 and provided by at least one digital video camera included in the camera system 112 of the marking device. According to other embodiments, detected color information may be output “directly” as part of the camera system data 134 by a color sensor and/or an optical flow chip constituting at least a portion of the camera system 112; alternatively, information provided by such a color sensor may be processed (e.g., by operation of the image analysis software) to provide the color information. The color sensor may output RGB values in one of various data formats known in the art. The color sensor may, for example, output one or more frequency values which may be processed by processor 176 to provide, e.g. RGB triplets having two bytes per color channel.

At step 902, reference color information is retrieved from, e.g., a local database located at the marking device (see reference color data 142 stored in local memory 124). Alternatively, the reference color information may be retrieved from a remote server. The reference color information may include, e.g., a collection of color values that have been observed empirically with a marking device and identified as being associated with a particular color of marking material. The collection of color values may include a single prototypical color value, a large variety of color values, or some number of color values in between. For each color of marking material, the associated color values of the reference color information provide a basis for comparison in determining how likely it is that the detected color information represents marking material of that color. Each color value in the reference color information may have at least one of an associated intensity value and an associated ambient light value as well. Intensity values may be used as an indicator of whether paint was freshly applied or whether paint is old. Ambient light levels, considered in concert with intensity values, provide further information in this regard. For example, in at a relatively higher ambient light level, fresh paint may exhibit relatively high intensity values. At relatively low ambient light levels, however, even fresh paint may be expected to exhibit relatively lower intensity values.

At step 903, the detected color information and the reference color information are processed to determine whether the detected color information is similar to one or more known marking material colors represented by the reference color information. The processing may include determining at least one likelihood of a match between the detected color information and at least a subset of the reference color information associated with at least one of the known marking material colors. The results of the processing are reported at step 904. If the likelihood of a match exceeds a predetermined detection threshold (e.g., 40% probability of a match, 60% probability of a match, etc.) for at least one known marking material color, at least the marking material color having the highest probability of a match may be reported, e.g., by displaying an indicator of the color, such as text containing the name of the matched color on a user interface screen of the marking device. The results of the processing also may be stored in memory at the marking device or transmitted to a remote server for storage in a database so that the results may be analyzed later. The indicator on the user interface may be displayed in color, such that the color of the indicator is the color that is being reported as the match. The operator of the marking device may then verify that the reported matching color is the color the operator intended to use, and the operator may investigate further if the wrong color is detected.

If more than one color match exceeding the detection threshold is found, in addition to reporting the color match having the highest probability of a match, the additional match or matches also may be reported. For example, the user interface of the marking device may list the suspected matches in descending order of likelihood. The user interface also may provide the calculated probabilities associated with each match (e.g. “Blue—90% confidence, Green—10% confidence”, “Red—40% confidence, Orange—20% confidence”, etc.). This information also may be stored locally or transmitted remotely for remote storage for later analysis. In other embodiments, the marking device may only report the most likely match found.

If no color match exceeding the detection threshold is found, the marking device may report that color detection failed. As with other detection scenarios listed above, this report may be presented locally at the marking device via a user interface in text or graphical format, and/or may be stored locally or remotely as part of a set of data for further analysis present. According to some embodiments, the closest matching color is always reported, even if it does not match closely enough to exceed a confidence threshold (discussed further below). The marking device may alert the operator whenever no sufficiently close match is found. In some cases, the fact that no match exceeding the confidence threshold was found may indicate that the marking device is not functioning properly and may require repair, cleaning, or adjustment. For example, a technician may believe that he is spraying blue paint, but the marking device may report that it cannot decisively determine the color of the paint is being sprayed, only that the closest match is red. If the technician had previously sprayed red paint with the marking device, this may indicate that some amount of paint had splattered onto the mechanisms of the marking device, and the marking device needs to be cleaned.

As mentioned above, comparing detected color information to reference color information may involve determining a likelihood that the detected color information is associated with marking material of a particular color. The likelihood may be determined based on a metric calculated using the detected color information and the reference color information. In an exemplary embodiment, the reference color information may be a representation of the APWA Uniform Color Code, which utilizes the color standards provided in standard ANSI Z.535.1 of the American National Standards Institute. This standard is described in detail, in, e.g., document ANSI Z535.1-2002, which is incorporated herein by reference in its entirety. The ANSI standard provides, for each of the standard colors, a standard color value (expressed in various color spaces including Munsell notation and CIE color space notation) associated with that color, as well as acceptable error tolerances of hue, value and chromaticity. In some embodiments, the detected color information may be compared to the ANSI standard color values and tolerances to determine whether the detected color value falls within the specified tolerance for one of the APWA-recognized colors.

In another embodiment, the reference color information may be sensed color data that was collected empirically using the marking device itself, so that reference color data is acquired using the same camera system that will be used to detect actual samples of dispensed marking material in the field during locate and marking operations. A data point in the database may be generated by a technician using a marking device equipped with a camera system as described herein to apply marking material of a known color to a surface and collect sensor data relating to the marking material that was applied to the surface. The sensed data may then be stored in the database as an entry under the correct color. For example, the database might include data such as is shown the following table:

| APWA Color/Krylon | | | | |
|---|---|---|---|---|
| Prod. No. | R | G | B | A |
| Green | 39 | 139 | 34 | 20 |
| (Sewer/Drain)/S03631 | 45 | 160 | 30 | 100 |
| | 43 | 175 | 22 | 200 |
| Blue (Potable | 10 | 10 | 200 | 20 |
| Water)/S03621 | 25 | 45 | 109 | 33 |
| Red (Electric Power | 167 | 24 | 37 | 70 |
| Lines)/S03611 | | | | |

Values in this table are provided purely for explanatory purposes and do not necessarily represent actual color data. Each row represents a single empirically collected data point in the database. The first column of the table indicates which APWA color the associated rows represent, i.e., the first three rows of data are APWA Green, rows four and five are APWA Blue, and row six is APWA Red. Columns two, three and four are RGB values for the red, green, and blue color channels, respectively (e.g., either provided directly by the camera system 112, or determined by processing of information provided by the camera system 112), and optional column five is values representing the level of ambient light (e.g., as provided by the ambient light sensor shown in FIG. 4B). The exemplary table is small for illustrative purposes, but in practice the table may include entries for each of the APWA colors typically used for locate and marking operations, and could include and number of data points (rows) for each APWA color (e.g., representing different values of “A” for different ambient lighting conditions). The table also is not meant to be limited to representing colors in the RGB color space, but may include color values expressed in any appropriate color space, such as various CIE color spaces (e.g., xy chromaticity coordinates). In some embodiments, additional columns may be present as well, including values for ambient temperature and/or ambient humidity at the time of color measurement, distance (range) from target, age of the paint (e.g., how long the marking material has been on the surface exposed to the environment) or other sensor values that may be provided to aid in the detection of marking material colors.

Calculating the metric for comparing detected color information to reference color information may include calculating a color difference (also known as a color distance) between, e.g., an RGB value of the detected color information and at least one RGB value of the reference color information. Various techniques for calculating a color difference between two colors are known in the art. For example, a Euclidean distance between two colors (r₁,g₁b₁) and (r₂,g₂,b₂) in an RGB color space may be calculated as follows:

Distance=\sqrt{(r₁−r₂)²+(g₁−g₂)²+(b₁−b₂)²}.

(See, e.g., http://en.wikipedia.org/wiki/Color_quantization and http://en.wikipedia.org/wiki/Euclidean_distance.)

Colors also may be represented in other color spaces besides RGB space, such as “Lab” color space (see, e.g., http://en.wikipedia.org/wiki/Lab_color_space) and CIE 1931 color space (see, e.g., http://en.wikipedia.org/wiki/CIE_{—}1931_color_space), and techniques for calculating a color difference in these spaces are known in the art as well (see, e.g., http://en.wikipedia.org/wiki/Color_difference).

Various techniques may be used for comparing the single detected color value to the plurality of reference color values associated with each of the APWA-approved colors. For example, a detected color value may be compared to each reference color value to determine a color distance, and for each APWA color, a minimum color distance may be derived. If, e.g., APWA Red has two entries in the color database, the color distance between the detected color value and both of the entries is calculated, and the smaller of the two is the minimum color distance for APWA Red. The color having the smallest minimum color distance may be determined to be the best match. A threshold distance also may be provided, such that when a minimum color distance exceeds the threshold distance, that color is determined not to be a match, whereas if the minimum color distance is below the threshold for a color, that color is a likely correct color. Other alternatives include determining, for each APWA color, an average color distance to each of the reference color values associated with that color. Numerous other metrics and methods of comparison are possible and will be apparent to one of skill in the art on the basis of this disclosure.

In an exemplary embodiment, a metric (based on, e.g., color distances, as discussed above) over the detected color value and the reference color values may provide, for each possible APWA color, a likelihood of the detected color value representing that color. The color having the greatest likelihood of being associated with the viewed marking material (or “match likelihood”) is determined to be the matching color. The likelihood of a match may be compared to a confidence threshold, e.g., 40% likelihood of a match, 60% likelihood of a match, etc. If the likelihood falls below the threshold, it may be determined that no color matches the detected color information. Similarly, if more than one color matches the detected color information, a warning may be issued to a user that the match result may be suspect because an alternative color also is a close match. As discussed above, the warning may include a message displayed on a user interface of the marking device indicating that no sufficiently likely color match was found. The marking device also may issue an audible warning, such as an alarm beep or a prerecorded human voice warning message, to alert the operator of the marking device to the fact that the color detection did not complete successfully.

Referring to FIG. 7B, a flow diagram of an example of a method 800 for determining marking material color is presented, according to yet another embodiment, in which the camera system data 134 includes video image information, in the form of frames of a digital video clip (e.g., as provided by a digital video camera of the camera system 112). In one exemplary implementation, as discussed above in connection with the method 900 outlined in FIG. 7A, the method 800 of FIG. 7B may be performed by the processing unit 122 of control electronics 110 of a marking device, executing one or more programs (such as the image analysis software 114), to process the camera system data 134, and/or to process and/or generate one or more of image data 134, color data 134, and reference color data 142 stored in local memory 124 of the control electronics 110.

At step 801, frames of a digital video clip that are included in the camera system data 134 may be stored (e.g., in local memory 124 as image data 134). At step 802, each frame of the image data may be compared to previous frames of the image data (e.g., via the image analysis software). At step 803, it is determined (e.g., by the image analysis software) whether an amount of detected color change exceeds a certain predetermined threshold. If the threshold is not exceeded, the method 800 may return, for example, to step 802 to continue processing the image data. At step 804, a color of the marking material being dispensed may be determined. Further details relating to these steps are discussed in greater detail below with respect to an exemplary embodiment with reference to FIG. 7C.

Referring to FIG. 7C, a flow diagram of a more detailed example of a method 500 for determining marking material color by processing one or more frames of image data is presented. For performing color detection according to one embodiment of the present invention, the method 500 may be executed alone or in combination with the method 600 of FIG. 8. The method 500 may include, but is not limited to, the following steps, which may be executed in any suitable order.

At step 510, the starting of the motion of imaging-enabled marking device 100 is sensed and one or more of the digital video cameras 112 may be activated. For example, the processing unit 122 may monitor readings from the IMU 116 to determine the beginning of any motion of the imaging-enabled marking device 100. Additionally, or alternatively, the processing unit 122 may monitor an output of the optical flow algorithm 138 to determine the beginning of any motion of the imaging-enabled marking device 100. When the starting motion is sensed, the camera system 112 may be activated.

At step 512, the image analysis software 114 may monitor a status of the actuation system 130 in real time and tag some frames of the camera system data 134 as “actuation-off” or “actuation-on.” In this way, the image analysis software 114 may differentiate between frames of the camera system data 134 captured when not dispensing marking material and frames captured when dispensing marking material. Alternatively, the image analysis software 114 may tag the frames by comparing their timestamps with a timed record of actuation events. To account for some possible delay between the actuation system being actuated by a user and the marking material hitting the target surface, a certain number of frames (e.g., 10, 20, 30, or 60 frames) captured immediate after an actuation event may not be tagged as “actuation on.”

At step 514, certain frames of the digital video clip that are captured while the imaging-enabled marking device 100 is in motion may be stored. For example, every n^{th} frame (e.g., every 5^{th}, 10^{th} or 20^{th} frame) of the camera system data 134 from the camera system 112 may be passed to the processing unit 122 and stored in the local memory 124. Each frame of the camera system data 134 may be time-stamped with the current date and time from the processing unit 122. Additionally, some frames may be encoded with “actuation-off” or “actuation-on” data as discussed above.

At step 516, individual frames of the camera system data 134 may be processed to remove high frequency components (which may represent small image details) and thereafter may be compared to previous frames of image data. For example, each frame of the camera system data 134 may be passed through a low-pass filter to remove high frequency components. Each frame of the camera system data 134 may then be compared to previous frames of the camera system data 134. The comparison may involve subtracting adjacent frames of the camera system data 134 from a current frame of the camera system data 134 and looking for sufficiently large sections of color change in one or more portions of the frame, such as in an expected marked portion determined based on a camera mounting position. As a more specific example, the marking region 410 of the mark-frame 400 of FIG. 6B may be such an expected marked portion in which the image analysis software 114 may attempt to detect color change.

At decision step 518, it is determined whether an amount of detected color change exceeds a certain predetermined threshold. In the case the target surface and the marking material have similar colors (e.g., green marking material being dispensed on green grass edge), an expected color change may be less prominent. Accordingly, the threshold for the amount of color change may be reduced under such circumstances. If the threshold is exceeded, it may be determined that the marking material has been dispensed and the method 500 may proceed, for example, to step 520. If the threshold is not exceeded, the method 500 may return, for example, to the step 516 to continue processing the camera system data 134.

In some embodiments, the failure to detect a significant color change between two frames (e.g., captured, respectively, before and after an actuation event) may be treated as an indication of a possible malfunction of the imaging-enabled marking device 100 (e.g., a marking material container being empty or not being loaded properly into a dispenser, or the actuation system 130 is not functioning properly to cause dispensing of marking material). Accordingly, the imaging-enabled marking device 100 may alert a user (e.g., a locate technician) and/or recommend a diagnostic check. Additionally, or alternatively, the imaging-enabled marking device 100 may record the incident in an electronic record of the locate and marking operation for future review and evaluation. For example, the electronic record may be examined by a regulator and/or an insurer for auditing purposes (e.g., to verify whether the locate and marking operation has been properly conducted). As another example, the electronic record may be analyzed during damage investigation in the event of an accident during subsequent excavation.

At step 520, a color of the marking material being dispensed may be determined by comparing an average color (and/or one or more most prevalent colors) of a portion of the frame that shows fresh marking material (e.g., the marking region 410 of the mark-frame 400 shown in FIG. 6B) to a previously stored database of marking material colors, such as information stored in the reference color data 142. For example, the information stored in the reference color data 142 may include marking material colors taken from previous frames and may be trained using k-means clustering. When a match is found between the color information of the current frame of the camera system data 134 and a certain color in reference color data 142, an identification of the matching color may be logged in the color data 136 of the local memory 124.

Various image processing techniques may be used at step 520 to facilitate the determination of marking material color. For instance, in order to reduce the effect of shadows that may make the marking material appear darker, an entire frame may be lightened to a baseline darkness.

Additionally, once a matching color is determined, it may be compared against an expected color. For instance, a marking material color may be expected depending on a type of underground facilities being marked (e.g., as shown in Table 1 above). If the matching color is not as expected, the imaging-enabled marking device 100 may alert a user (e.g., a locate technician) of a potential error. Additionally, or alternatively, the imaging-enabled marking device 100 may record the incident in an electronic record of the locate and marking operation for future review and evaluation.

At step 522, the ending of the motion of the imaging-enabled marking device 100 is sensed and the digital video cameras 112 may be deactivated. For example, the processing unit 122 may monitor readings from the IMU 116 to determine the ending of any motion of the imaging-enabled marking device 100. Additionally, or alternatively, the processing unit 122 may monitor an output of the optical flow algorithm 138 to determine the ending of any motion of the imaging-enabled marking device 100. When the ending motion is sensed, digital video cameras 112 may be deactivated.

Referring again to FIG. 7C, the method 500 describes a process that can be executed in real time (e.g., while a locate technician is working at a job site) for determining marking material color. In other embodiments, a process of determining marking material color may be performed by post-processing the captured image data. For example, certain frames of the image data may be saved and post-processed at any time after the completion of the locate operation, rather than in real time during the locate operation.

Referring to FIG. 8, a flow diagram of an example of a method 600 of determining marking material color by performing a pixel intensity analysis is presented. For performing color detection according to the present disclosure, the method 600 may be executed alone or in combination with method 500 of FIG. 7C. In particular, the method 600 may be useful for distinguishing previously dispensed marking material (e.g., dry paint) from freshly dispensed marking material in a frame of the camera system data 134. The method 600 may include, but is not limited to, the following steps, which may be executed in any suitable order.

At step 610, the starting of the motion of the imaging-enabled marking device 100 is sensed and the camera system 112 may be activated. For example, the processing unit 122 may monitor readings from the IMU 116 to determine the beginning of any motion of the imaging-enabled marking device 100. Additionally, or alternatively, the processing unit 122 may monitor an output of the optical flow algorithm 138 to determine the beginning of any motion of the imaging-enabled marking device 100. When the starting motion is sensed, digital video cameras 112 may be activated.

At step 612, the image analysis software 114 may monitor a status of the actuation system 130 in real time and tag some frames of the camera system data 134 as “actuation-off” or “actuation-on.” In this way, the image analysis software 114 may differentiate between frames of the camera system data 134 captured when not dispensing marking material and frames captured when dispensing marking material. Alternatively, the image analysis software 114 may tag the frames by comparing their timestamps with a timed record of actuation events. To account for some possible delay between the actuation system being actuated by a user and the marking material hitting the target surface, a certain number of frames (e.g., 10, 20, 30, or 60 frames) captured immediately after an actuation event may not be tagged as “actuation on.”

At step 614, certain frames of the digital video clip that are captured while the imaging-enabled marking device 100 is in motion may be stored. For example, every n^{th} frame (e.g., every 5^{th}, 10^{th} or 20^{th} frame) of the camera system data 134 from the camera system 112 may be passed to the processing unit 122 and stored in the local memory 124. Each frame of camera system data 134 may be time-stamped with the current date and time from the processing unit 122. Additionally, some frames may be encoded with “actuation-off” or “actuation-on” data as discussed above.

At step 616, the pixel value analysis algorithm 140 may query the local memory 124 for a frame of the camera system data 134 that shows or is expected to show marking material dispensed on a target surface (e.g., a “mark-frame” as discussed above). For instance, the pixel value analysis algorithm 140 may query the local memory 124 for a frame of the camera system data 134 that is tagged with “actuation-on” information. The mark-frame 400 of FIG. 6B is an example of a frame of the camera system data 134 that may be tagged with “actuation-on” information. In this example, freshly dispensed blue marking material is shown in the mark-frame 400 of FIG. 6B.

At step 618, the pixel value analysis algorithm 140 may distinguish any marked portions and any unmarked portions of the frame of the camera system data 134 by analyzing pixel intensities. A predetermined intensity threshold that is selected according to a characteristic intensity of freshly dispensed marking material may be stored in local memory 124. This predetermined intensity threshold may be color independent. For example, the pixel value analysis algorithm 140 may classify all pixels having an intensity value below this intensity threshold as “no marking material.” Conversely, the pixel value analysis algorithm 140 may classify all pixels having an intensity value at or above this intensity threshold as “marking material.”

At step 620, the pixel value analysis algorithm 140 may remove some or all of the pixels classified as “no marking material” and save some or all of the pixels classified as “marking material” from the frame of the camera system data 134.

At step 622, the pixel value analysis algorithm 140 may analyze the pixels saved in step 620 with respect to their color information. For example, the pixel value analysis algorithm 140 may generate an RGB color distribution of the remaining portion of the image, which may be a close approximation of an RGB color distribution for the fresh marking material. From the generated RGB color distribution, the pixel value analysis algorithm 140 may identify a color (e.g., expressed in terms of its red, green, and blue components, or in some other suitable color coordinate system) as being most prevalent (e.g., having a highest occurrence). Thereby, the pixel analysis algorithm 140 may identify a candidate color of the fresh marking material. For example, a lookup table (not shown) may be used to match detected colors or ranges of detected colors to possible marking material colors. The candidate marking material color that is identified may be stored in the color data 136 of the local memory 124.

Continuing with step 622, as an alternative to or in addition to the processing carried out in steps 618 and 620, the pixel value analysis algorithm 140 may analyze color information in one or more portions of each frame of the camera system data 134 that are expected to show fresh marking material, such as the frame subsection B of the mark-frame 400 shown in FIG. 6B. As discussed above, a location of such an expected marked portion may be predictable based on a mounting position of the digital video cameras 112. For example, when the digital video cameras 112 are mounted directly above a nozzle of a marking material dispenser, fresh marking material may be expected at or near the center of a frame captured when the dispenser is actuated to dispense marking material (e.g., when a trigger of the dispenser is held in an actuated position by a user). In some embodiments, the location of an expected marked portion in a frame may be predicted further based on a typical distance (e.g., about 10 to 13 inches) between the digital video cameras 112 and the surface to be marked when the marking device 100 is held by a technician during normal use. Alternatively, or additionally, an actual distance between the digital video cameras 112 and the surface to be marked may be used to predict the location of an expected marked portion in a frame. For example, one or more range finder devices (e.g., a sonar range finder and/or a laser range finder) may be employed to measure the actual distance between the digital video cameras 112 and the surface to be marked as one or more frames of images are being captured by the digital video cameras 112. In some implementations, such a range finder may be mounted on the marking device 100 adjacent the digital video cameras 112 and may be activated whenever images are being captured by the digital video cameras 112.

At step 624, the ending of the motion of the imaging-enabled marking device 100 is sensed and the camera system 112 may be deactivated. For example, the processing unit 122 may monitor readings from the IMU 116 to determine the ending of any motion of the imaging-enabled marking device 100. Additionally, or alternatively, the processing unit 122 may monitor an output of the optical flow algorithm 138 to determine the ending of any motion of the imaging-enabled marking device 100. When the ending motion is sensed, the digital video cameras 112 may be deactivated.

Referring again to FIG. 8, the method 600 describes a process that can be executed in real time for determining marking material color by performing a pixel intensity analysis. In other embodiments, a process of determining marking material color may be performed by post-processing captured image data. For example, certain frames of the image data may be saved and post-processed at any time after the completion of the locate operation, rather than in real time during the locate operation. Referring again to FIGS. 4 through 8, the method 500 of FIG. 7 and/or the method 600 of FIG. 8 may be used for performing marking material color detection according to various embodiments of the present disclosure.

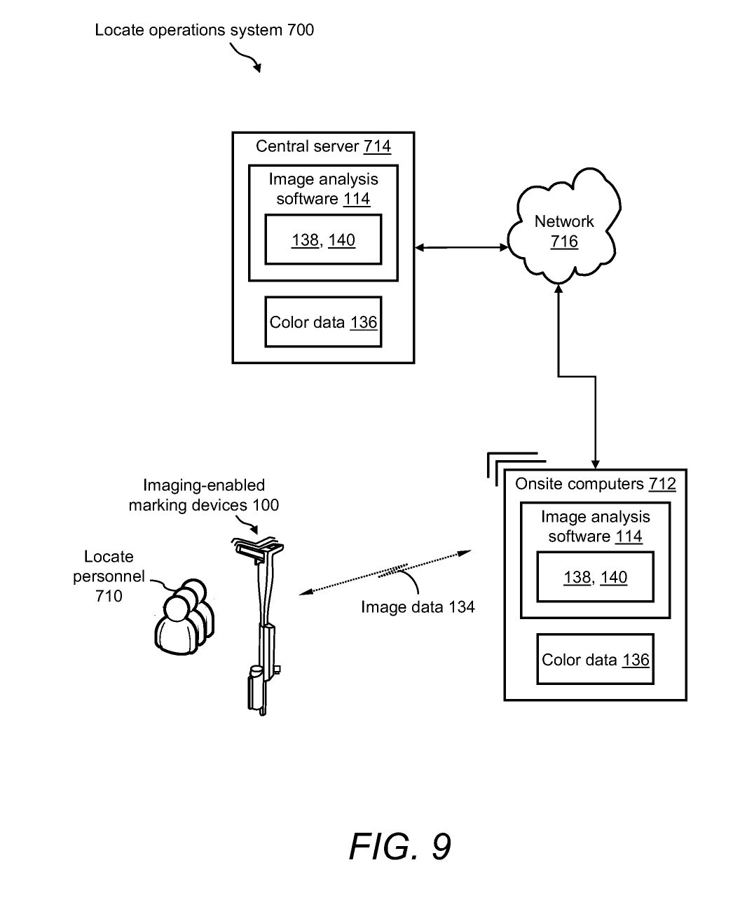

Referring to FIG. 9, a functional block diagram of an example of a locate operations system 700 that includes a network of imaging-enabled marking devices 100 is presented. The locate operations system 700 may include any number of imaging-enabled marking devices 100 that are operated by, for example, respective locate personnel 710. Examples of locate personnel 710 include locate technicians. Associated with each locate personnel 710 and/or imaging-enabled marking device 100 may be an onsite computer 712. Therefore, the locate operations system 700 may also include any number of onsite computers 712.

Each onsite computer 712 may be any suitable computing device, such as, but not limited to, a computer that is present in a vehicle that is being used by locate personnel 710 in the field. For example, an onsite computer 712 may be a portable computer, a personal computer, a laptop computer, a tablet device, a personal digital assistant (PDA), a cellular radiotelephone, a mobile computing device, a touch-screen device, a touchpad device, or generally any device including, or connected to, a processor. Each imaging-enabled marking device 100 may communicate via a communication interface 126 with its respective onsite computer 712. For instance, each imaging-enabled marking device 100 may transmit camera system data 134 to its respective onsite computer 712.

While an instance of the image analysis software 114 that includes, for example, the optical flow algorithm 138 and the pixel value analysis algorithm 140 for generating the color data 136 may reside and operate at each imaging-enabled marking device 100, an instance of the image analysis software 114 may also reside at each onsite computer 712. In this way, the camera system data 134 may be processed at the onsite computer 712 in addition to, or instead of, at the imaging-enabled marking device 100. Additionally, the onsite computer 712 may process the camera system data 134 concurrently with the imaging-enabled marking device 100.

Additionally, the locate operations system 700 may include a central server 714. The central server 714 may be a centralized computer, such as a central server of, for example, an underground facility locate service provider. One or more networks 716 may provide a communication medium by which information may be exchanged between the imaging-enabled marking devices 100, the onsite computers 712, and/or the central server 714. The networks 716 may include, for example, any local area network (LAN), wide area network (WAN), and/or the Internet. The imaging-enabled marking devices 100, the onsite computers 712, and/or the central server 714 may be connected to the networks 716 by any wired and/or wireless networking technologies.

While an instance of the image analysis software 114 may reside and operate at each imaging-enabled marking device 100 and/or at each onsite computer 712, an instance of the image analysis software 114 may also reside at the central server 714. In this way, the camera system data 134 may be processed at the central server 714 in addition to, or instead of, at each imaging-enabled marking device 100 and/or at each onsite computer 712. Additionally, the central server 714 may process the camera system data 134 concurrently with the imaging-enabled marking devices 100 and/or the onsite computers 712.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

As a more specific example, an illustrative computer that may be used for marking material color detection in accordance with some embodiments comprises a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the illustrative computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An apparatus for determining a color of marking material dispensed by a marking device onto a surface to mark a presence or an absence of at least one underground facility within a dig area, wherein at least a portion of the dig area is planned to be excavated or disturbed during excavation activities, the apparatus comprising:
at least one communication interface;
at least one memory to store processor-executable instructions and reference color information regarding a plurality of marking material colors; and
at least one processor communicatively coupled to the at least one memory and the at least one communication interface, wherein, upon execution of the processor-executable instructions, the at least one processor:
A) analyzes camera system data associated with the surface being marked to obtain detected color information relating to the marking material dispensed by the marking device, the camera system data being provided by at least one camera system attached to the marking device;
B) retrieves, from the at least one memory, the reference color information; and
C) generates marking material color information based at least in part on the detected color information and the reference color information.

2. The apparatus of claim 1, wherein in C), the at least one processor:
C1) identifies, based at least in part on the detected color information and the reference color information, each of the plurality of marking material colors as unlikely to match the marking material dispensed by the marking device.

3. The apparatus of claim 1, further comprising:
the marking device; and
the camera system, attached to the marking device, to provide the camera system data.

4. The apparatus of claim 3, wherein the camera system comprises at least one digital camera.

5. The apparatus of claim 4, wherein the at least one digital camera includes at least one digital video camera.

6. The apparatus of claim 3, wherein the camera system comprises at least one color sensor to provide color information as part of the camera system data.

7. The apparatus of claim 3, wherein the camera system comprises at least one optical flow chip to provide at least one of image information, color information and motion information as part of the camera system data.

8. The apparatus of claim 3, wherein the camera system comprises at least one ambient light sensor to provide ambient light level information as part of the camera system data.

9. The apparatus of claim 3, wherein the camera system comprises:
at least one color sensor to provide color information as part of the camera system data.
at least one optical flow chip to provide at least one of image information, color information and motion information as part of the camera system data.
at least one ambient light sensor to provide ambient light level information as part of the camera system data.

10. The apparatus of claim 1, wherein in C), the at least one processor: C1) identifies, based at least in part on the detected color information and the reference color information, at least one of the plurality of marking material colors as a candidate color for the marking material dispensed by the marking device.

11. The apparatus of claim 10, wherein the camera system data includes at least image data, wherein the image data represents a first image and a second image, and wherein in A), the at least one processor:
A1) determines whether the second image is likely to contain an image of freshly dispensed marking material, at least in part by comparing the first and second images to detect a possible color change.

12. The apparatus of claim 11, wherein in A1), the at least one processor:
A2) subtracts the first image from the second image to obtain difference information; and
A3) analyzes the difference information to detect the possible color change.

13. The apparatus of claim 12, wherein in A1), the at least one processor:
A2) transforms the second image from a spatial domain to a frequency domain to obtain first frequency domain image data;
A3) removes at least one high frequency component from the first frequency domain image data to obtain second frequency domain image data;
A4) transforms the second frequency domain image data from the frequency domain to the spatial domain to obtain a processed second image; and
A5) compares the first image and the processed second image to detect the possible color change.

14. The apparatus of claim 10, wherein the marking device comprises an actuation system for causing the marking material to be dispensed, and wherein the at least one image comprises a first image captured prior to an actuation event of the actuation system to start dispensing the marking material and a second image captured after the actuation event.

15. The apparatus of claim 10, wherein in A), the at least one processor:
A1) identifies at least one portion of the at least one image as being likely to contain an image of freshly dispensed marking material.

16. The apparatus of claim 15, wherein in A1), the at least one processor:
A2) analyzes intensity information of the at least one portion of the least one image to determine whether an intensity threshold is exceeded.

17. The apparatus of claim 16, wherein the intensity threshold is selected based at least in part on an expected marking material color corresponding to a type of facilities being marked.

18. The apparatus of claim 15, wherein in A1), the at least one processor identifies the at least one portion of the at least one image based at least in part on a mounting position of the at least one camera system on the marking device.

19. The apparatus of claim 18, wherein in A1), the at least one processor identifies the at least one portion further based on an estimated distance between the at least one camera system and the surface to be marked.

20. The apparatus of claim 15, wherein in A), the at least one processor:
A2) obtains the detected color information without analyzing any portion of the at least one image outside the at least one portion that is identified as being likely to contain an image of freshly dispensed marking material.

21. The apparatus of claim 15, wherein the detected color information comprises a most prevalent color of the at least one portion of the at least one image.

22. The apparatus of claim 15, wherein the detected color information comprises an average color of the at least one portion of the at least one image.

23. In a system comprising at least one communication interface, at least one memory to store processor-executable instructions, and at least one processor communicatively coupled to the at least one memory and the at least one communication interface, a method for determining a color of marking material dispensed by a marking device onto a surface to mark a presence or an absence of at least one underground facility within a dig area, wherein at least a portion of the dig area is planned to be excavated or disturbed during excavation activities, the method comprising:
A) analyzing camera system data associated with the surface being marked to obtain detected color information relating to the marking material dispensed by the marking device, the camera system data being provided by at least one camera system attached to the marking device;
B) retrieving, from the at least one memory, reference color information regarding a plurality of marking material colors; and
C) generating marking material color information based at least in part on the detected color information and the reference color information.

24. At least one non-transitory computer-readable storage medium encoded with at least one program including processor-executable instructions that, when executed by at least one processor, perform a method for determining a color of marking material dispensed by a marking device onto a surface to mark a presence or an absence of at least one underground facility within a dig area, wherein at least a portion of the dig area is planned to be excavated or disturbed during excavation activities, the method comprising:
A) analyzing camera system data associated with the surface being marked to obtain detected color information relating to the marking material dispensed by the marking device, the camera system data being provided by at least one camera system attached to the marking device;
B) retrieving, from the at least one memory, reference color information regarding a plurality of marking material colors; and
C) generating marking material color information based at least in part on the detected color information and the reference color information.

25. A marking apparatus for performing a marking operation to mark on a surface a presence or an absence of at least one underground facility, the marking apparatus comprising:
at least one actuator to dispense a marking material so as to form at least one locate mark on the surface to mark the presence or the absence of the at least one underground facility;
at least one camera system to provide camera system data relating to the surface being marked;
at least one user interface including at least one display device;
at least one communication interface;
at least one memory to store processor-executable instructions; and
at least one processor communicatively coupled to the at least one memory, the at least one communication interface, the at least one user interface, and the at least one actuator, wherein upon execution of the processor-executable instructions, the at least one processor:
A) analyzes the camera system data to obtain detected color information relating to the marking material dispensed by the marking device;
B) retrieves, from the at least one memory, reference color information regarding a plurality of marking material colors; and
C) generates marking material color information based at least in part on the detected color information and the reference color information.

26. An apparatus according to claim 25, wherein the marking material color information indicates that no marking material was detected.
